(19) United States
(12) Patent Application Publication
(10) Pub. No.: US 2013/0028243 A1
(43) Pub. Date: Jan. 31, 2013

(54) FACILITATING CHANNEL SOUNDING FOR MULTIPLE INPUT AND MULTIPLE OUTPUT (MIMO) TRANSMISSIONS

(71) Applicants: Maarten Menzo Wentink, Naarden (NL); Didier Johannes Richard Van Nee, Naarden (NL)

(72) Inventors: Maarten Menzo Wentink, Naarden (NL); Didier Johannes Richard Van Nee, Naarden (NL)

(73) Assignee: QUALCOMM Incorporated, San Diego, CA (US)

(21) Appl. No.: 13/189,614

(22) Filed: Jul. 25, 2011

(51) Int. Cl. H04W 84/02

(52) U.S. Cl. 370/338

(57) ABSTRACT

Methods and apparatuses are provided for facilitating channel sounding for multiple-input and multiple-output (MIMO) transmissions between an access terminal and an access point. According to one feature, the access point may transmit a data frame to an access terminal using a plurality of spatial streams and a plurality of antennas. The access terminal may transmit an acknowledgement frame back to the access point, where the acknowledgement frame is transmitted as both a sounding signal and as to acknowledge receipt of the data frame. According to another feature, the access point may transmit a data frame and a matrix request frame to an access terminal. The access terminal may determine channel matrix information, and may send the channel matrix information together with an acknowledgement frame back to the access point.

### BACKGROUND

1. Field

Various features disclosed herein pertain generally to wireless communication systems, and at least some features pertain to devices and methods for facilitating estimation or determination of channel matrix information for data transmissions over Spatial Division Multiple Access or other similar technologies.

2. Background

Access terminals, such as mobile phones, pagers, wireless modems, personal digital assistants, personal information managers (PIMs), personal media players, palmtop computers, laptop computers, or any other device with a processor, that communicate with other devices through wireless signals are becoming increasingly popular and are used more frequently. Such increases in distribution and use of access terminals have resulted in the demand for greater bandwidth. In order to address the issue of increasing bandwidth demands, different schemes are being developed to allow multiple access terminals to communicate with a single access point by sharing channel resources (e.g., time and frequency resources) while achieving high data throughputs.

Multiple Input or Multiple Output (MIMO) technology represents one such approach that has emerged as a popular technique for the next generation communication systems. MIMO technology has been adopted in several emerging wireless communications standards such as the Institute of Electrical and Electronics Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters).

One common and typical MIMO scheme is Spatial Division Multiple Access (SDMA). SDMA represents an example of a multiple access scheme which enables multiple streams transmitted to different receivers at the same time to share the same frequency channel and, as a result, provide higher user capacity. In a multiple-access MIMO system based on SDMA, an access point can communicate with one or more access terminals at any given moment.

A SDMA system conventionally employs one or more transmit antennas and one or more receive antennas for data transmission. A SDMA channel formed by the various transmit and receive antennas may be decomposed into a particular number of spatial streams. These spatial streams may be used to transmit a number of independent data streams to achieve greater overall throughput.

MIMO transmissions, such as SDMA communications, may use a sounding signal to obtain channel information that can be employed in beamforming. Typically, such sounding signals comprise a signal used solely for the purpose of channel sounding. Therefore, there is a need for a method, apparatus, and/or system that employs channel sounding in various data transmission schemes in which the sounding signal can also comprise transmission data for use by the receiving device.

### SUMMARY

The following presents a simplified summary of one or more embodiments in order to provide a basic understanding of some embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Various features facilitate channel sounding in multiple-input multiple-output (MIMO) transmissions of data. One feature provides access terminals adapted to facilitate such channel sounding. These access terminals may include a communications interface and a processing circuit coupled to the communications interface. The communications interface may include a plurality of antennas adapted for wireless communications. For example, the communications interface may be adapted to facilitate communications in an Institute of Electrical and Electronics Engineers (IEEE) 802.11 wireless local area network (WLAN), as well as via a spatial division multiple access (SDMA) scheme.

According to at least one implementation, the processing circuit can be adapted to receive a data frame during a first transmission opportunity, where the data frame is received via a plurality of spatial streams and using at least some of the plurality of antennas of the communications interface. The processing circuit may further send an acknowledgement frame during a second transmission opportunity to acknowledge receipt of the data frame. The acknowledgement frame is also transmitted as a sounding signal. The acknowledgement frame may be transmitted using the same spatial streams and the same antennas used to receive the data frame. The acknowledgement frame may be sent concurrently with, or in a sequential order with acknowledgement frames transmitted by one or more other access terminals. The processing circuit may also be adapted to receive a start indicator frame during the first transmission opportunity, where the start indicator frame indicates a start time when the access terminal is to send the acknowledgement frame during the second transmission opportunity.

According to at least one other implementation, the processing circuit can be adapted to receive a first transmission via the communications interface, where the first transmission includes a data frame and a matrix request frame. The first transmission can be received via a plurality of spatial streams and using a plurality of antennas of the communications interface. The processing circuit may determine channel matrix information for the access terminal. The channel matrix information may be determined by measuring a received signal to ascertain one or more channel characteristics, and generating data depicting the one or more channel characteristics. The one or more channel characteristics may comprise at least one of an interference level, a signal strength, a noise floor, a direction of departure or a direction of arrival.

The processing circuit may send a second transmission that includes an acknowledgement frame to acknowledge receipt of the data frame and a channel matrix information frame that includes the channel matrix information determined by the access terminal. The second transmission can be sent concurrently with an acknowledgement frame transmitted by at least one other access terminal, or in a sequential order with acknowledgement frames transmitted by one or more other access terminals.

Methods operational in an access terminal are also provided according to one feature for facilitating channel sounding. In at least one implementation of such methods, for instance, a data frame may be received during a first transmission opportunity via a plurality of spatial streams and using a plurality of antennas. During a second transmission opportunity, an acknowledgement frame may be sent as a sounding signal, and also to acknowledge receipt of the data frame. The acknowledgement frame may be transmitted using the same spatial streams and the same antennas used to receive the data frame.

In at least one other implementation of such methods, a first transmission is received that includes a data frame and a matrix request frame. Channel matrix information for the access terminal is determined, and a second transmission is transmitted. The second transmission can include an acknowledgement frame to acknowledge receipt of the data frame and a channel matrix information frame that includes the channel matrix information determined by the access terminal.

Another feature provides access points adapted to facilitate channel sounding. Such an access point may include a communications interface adapted for wireless communications, and a processing circuit coupled to the communications interface. The communications interface may be adapted to facilitate wireless communications in an Institute of Electrical and Electronics Engineers (IEEE) 802.11 wireless local area network (WLAN).

According to at least one implementation, the processing circuit may be adapted to transmit a respective data frame to each access terminal of a plurality of access terminals during a first transmission opportunity, where each data frame is transmitted to each access terminal via a plurality of spatial streams and using a plurality of antennas of the communications interface. A start indicator frame may also be transmitted during the first transmission opportunity. The respective data frames may be transmitted to each access terminal via a spatial division multiple access (SDMA) scheme.

The processing circuit may then receive an acknowledgement frame from each of the access terminals during a second transmission opportunity. Such acknowledgement frames may be received at least substantially concurrently via a spatial division multiple access (SDMA) scheme, or in a sequential order during the second transmission opportunity. The acknowledgement frames are received as a sounding signal, as well as anto acknowledge receipt of the data frame. Each acknowledgement frame may be received using the same spatial streams and the same antennas used by the access point to transmit the data frame.

Using reception of the acknowledgement frame to ascertain one or more channel characteristics, the processing circuit may then determine channel matrix information associated with each access terminal. The processing circuit may determine channel matrix information by measuring a signal associated with the received acknowledgement frame to ascertain one or more channel characteristics, such as an interference level, a signal strength, a noise floor, a direction of departure or a direction of arrival. The one or more channel characteristics may be measured using at least one of a least-square estimation, a Bayesian estimation or a minimum mean square error (MMSE) estimation.

According to at least one other implementation, the processing circuit may be adapted to transmit a first transmission to an access terminal via the communications interface, where the first transmission includes a data frame and a matrix request frame. The first transmission can be transmitted in parallel with at least one other transmission sent to at least one other access terminal. The first transmission and the at least one other transmission can be transmitted in parallel via a spatial division multiple access (SDMA) scheme. The first transmission may also include a start indicator frame to indicate a start time when the access terminal is to send a second transmission.

The processing circuit may then receive a second transmission via the communications interface, where the second transmission includes an acknowledgement frame to acknowledge receipt of the data frame and a channel matrix information frame that includes channel matrix information determined by the access terminal. The second transmission can be received in parallel with at least one acknowledgement frame transmitted by the at least one other access terminal, or in a sequential order with at least one acknowledgement frame transmitted by the at least one other access terminal.

Methods operational in an access point are also provided according to one feature for facilitating channel sounding. For instance, according to at least one implementation of such methods, a respective data frame may be transmitted to each access terminal of a plurality of access terminals during a first transmission opportunity. Each data frame is transmitted to each access terminal via a plurality of spatial streams and using a plurality of antennas. An acknowledgement frame can be received from each access terminal during a second transmission opportunity, where each acknowledgement frame is received as a sounding signal and to acknowledge receipt of the data frame. Each acknowledgement frame may be received using the same spatial streams and the same antennas used to transmit the data frame. Using reception of the acknowledgement frame to ascertain one or more channel characteristics, channel matrix information associated with each access terminal may be determined.

According to at least one other implementation of such methods, a first transmission including a data frame and a matrix request frame may be transmitted to an access terminal, where the first transmission is transmitted in parallel with at least one other transmission sent to at least one other access terminal. A second transmission may then be received, which includes an acknowledgement frame to acknowledge receipt of the data frame and a channel matrix information frame that includes channel matrix information determined by the access terminal.

### BRIEF DESCRIPTION OF THE DRAWINGS

Various features, characteristics, and advantages may become apparent from the detailed description set forth below when taken in conjunction with the drawings in which like reference characters identify correspondingly throughout.

FIG. 1 is a block diagram illustrating an example of a wireless communication system 100 adapted for multiple-access using multiple-input multiple-output (MIMO) with access points and access terminals.

FIG. 2 is a block diagram illustrating an example of a video transmission environment in which the various embodiments of access points and access terminals may be implemented.

FIG. 3 is a flow diagram illustrating an example of a frame exchange between an access point and an access terminal for facilitating channel sounding by implicit feedback.

FIG. 4 is a block diagram illustrating an example of a transmission scheme between an access point and multiple access terminals for facilitating channel sounding by implicit feedback.

FIG. 5 is a block diagram illustrating another example of a transmission scheme between an access point and multiple access terminals for facilitating channel sounding by implicit feedback.

FIG. 6 is a flow diagram illustrating an example of a frame exchange between an access point and an access terminal for facilitating channel sounding by explicit feedback.

FIG. 7 is a block diagram illustrating an example of a transmission scheme between an access point and multiple access terminals including parallel uplink transmissions for facilitating channel sounding by explicit feedback.

FIG. 8 is a block diagram illustrating an example of a transmission scheme between an access point and multiple access terminals including serial uplink transmissions for facilitating channel sounding by explicit feedback.

FIG. 9 is a block diagram illustrating another example of a transmission scheme between an access point and multiple access terminals including serial uplink transmissions for facilitating channel sounding by explicit feedback.

FIG. 10 is a block diagram illustrating select components of an access terminal according to at least one implementation.

FIG. 11 is a flow diagram illustrating an example of at least one implementation of a method operational on an access terminal.

FIG. 12 is a flow diagram illustrating another example of at least one implementation of a method operational on an access terminal.

FIG. 13 is a block diagram illustrating select components of an access point according to at least one implementation.

FIG. 14 is a flow diagram illustrating an example of at least one implementation of a method operational on an access point.

FIG. 15 is a flow diagram illustrating another example of at least one implementation of a method operational on an access point.

FIG. 16 illustrates an example of a conventional IEEE 802.11 frame.

### DETAILED DESCRIPTION

In the following description, specific details are given to provide a thorough understanding of the described implementations. However, it will be understood by one of ordinary skill in the art that the implementations may be practiced without these specific details. For example, circuits may be shown in block diagrams in order not to obscure the implementations in unnecessary detail. In other instances, well-known circuits, structures and techniques may be shown in detail in order not to obscure the implementations.

The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation. The terms “access point” and “access terminal” as used herein are meant to be interpreted broadly. For example, an “access point” may refer to a device that facilitates wireless connectivity (for one or more access terminals) to a communication or data network. Examples of “access points” may include base stations, Node-B devices, femto cells, pico cells, etc. Furthermore, an “access terminal” may include mobile phones, pagers, wireless modems, personal digital assistants, personal information managers (PIMs), personal media players, palmtop computers, laptop computers, and/or other mobile communication/computing devices which communicate, at least partially, through a wireless or cellular network. Additionally, the term “channel matrix information” may refer to information associated with how a signal propagates from a transmitter using multiple antennas and/or spatial streams to a receiver. For example, “channel matrix information” may include interference levels, signal strength, noise floors, direction of departure, and/or direction of arrival.

### Overview

One feature provides apparatuses and methods for facilitating channel sounding in multiple-input multiple-output (MIMO) transmissions of data, such as streaming video data. According to a feature, an access point may send a data frame to a plurality of access terminals. The data frame is sent by the access point, and received by each access terminal using a plurality of antennas and spatial streams. Each access terminal may send an acknowledgement frame to the access point to acknowledge receipt of the data frame. In sending the acknowledgement frame, each access terminal uses the same antennas and the same number of spatial streams to transmit the acknowledgement frame to the access point. The access point can then use the reception of the acknowledgement frame to determine channel matrix information associated with a channel to each access terminal.

According to another feature, an access point may send a data frame together with a matrix request frame to one or more access terminals. Each access terminal that receives the data frame and the matrix request frame may determine channel matrix information for the channel between the access point and the access terminal. During a subsequent transmission opportunity, the access terminal may send both an acknowledgement frame to acknowledge receipt of the data frame, and a channel matrix information frame that includes the channel matrix information determined by the access terminal.

Using the channel matrix information, the access point can manipulate the various radiation beams directed toward one or more access terminals to achieve the greatest efficiency.

### Exemplary Network Environments

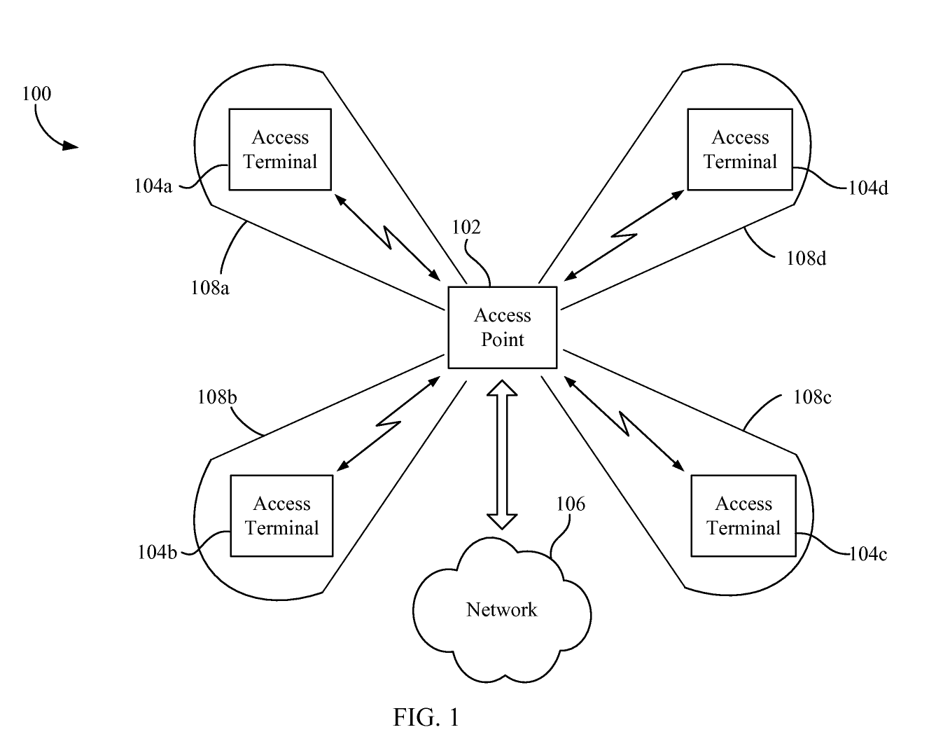

FIG. 1 is a block diagram illustrating an example of a wireless communication system 100 adapted for multiple-access using multiple-input multiple-output (MIMO) with access points and access terminals. For simplicity, only one access point 102 is shown in the wireless communication system 100 of FIG. 1. The access point 102 is generally a fixed station that communicates with the access terminals 104 (i.e., 104a-d), which can be fixed or mobile. The access point 102 can communicate with one or more access terminals 104 at any given moment on the downlink and uplink to provide access to a communication network 106 for the access terminals 104. The downlink (i.e., forward link) is the communication link from the access point 102 to the access terminals 104, and the uplink (i.e., reverse link) is the communication link from the access terminals 104 to the access point 102. An access terminal 104 may also be adapted to communicate peer-to-peer with another access terminal 104.

According to some implementations, the access point 102 and access terminals 104 are adapted to operate in an IEEE 802.11 wireless local area network (WLAN). More particularly, some implementations may be adapted for newer and faster versions of IEEE 802.11 for very high throughput (VHT), such as the version of the standard that will be referred to as IEEE 802.11ac when it is released. In at least some implementations, the MIMO adapted access point 102 may employ spatial division multiple access (SDMA), where multiple independent data streams (or data symbol streams) can be spatially multiplexed and transmitted concurrently to different receivers over the same frequency channel. Each spatially multiplexed data stream may be referred to herein as a “spatial stream.” As used herein, concurrent transmissions can include simultaneous transmissions, overlapping transmissions, and/or transmissions that are proximate in time (even if they are non-overlapping).

The wireless communication system 100 employs multiple transmit antennas and multiple receive antennas for data transmissions. The access point 102 can be equipped with a plurality of antennas and may represent the multiple-input (MI) for uplink transmissions and the multiple-output (MO) for downlink transmissions. A plurality of access terminals 104 may collectively represent the multiple-output for uplink transmissions and the multiple-input for downlink transmissions. For some implementations of SDMA, it is desirable for the access point 102 to have a number of antennas greater than the number of access terminals 104 if the data symbol streams for the plurality of access terminals 104 are not multiplexed in code, frequency or time by some means. The number of access terminals 104 may be greater than the number of access point antennas if the data symbol streams can be multiplexed using different code channels with CDMA, disjoint sets of subbands with OFDM, and so on. Each access terminal 104 of the plurality transmits user-specific data to and/or receives user-specific data from the access point 102. In general, each access terminal 104 of the plurality may be equipped with one or multiple antennas. The plurality of access terminals 104 can have the same or different numbers of antennas.

The SDMA adapted wireless communication system 100 may be a time division duplex (TDD) system or a frequency division duplex (FDD) system. For a TDD system, the downlink and uplink share the same frequency band. For a FDD system, the downlink and uplink use different frequency bands. The wireless communication system 100 may also utilize a single carrier or multiple carriers for transmission.

According to a feature, the MIMO adapted access point 102 may be configured to employ conventional beamforming using the multiple antennas for directional signal transmission and reception. For example, employing beamforming, the access point 102 may direct a relatively narrow radiation beam 108 (i.e., 108a-d) toward each of the access terminals 104. Such techniques are commonly known to those of ordinary skill in the art.

In order to manipulate the various beams 108 for greatest efficiency, the access point 102 needs to understand the characteristics of the channel being used to communicate with a particular access terminal 104. The process of obtaining these characteristics is conventionally referred to as “channel sounding” or “channel estimation.” As used in the present disclosure, the information obtained by channel sounding, which depicts the channel characteristics for the channel employed for transmissions between the access point 102 and an access terminal 104, may be referred to as “channel matrix information.” Such information (channel matrix information) may generally describe how a signal propagates from a transmitter (e.g., the access point 102) using multiple antennas and/or spatial streams to a receiver (e.g., the access terminal 104), and generally represents the combined effect of, for example, scattering, fading, and power decay with distance. By way of example and not limitation, some channel characteristics included in the channel matrix information may comprise one or more of interference levels, signal strength, noise floors, direction of departure, or direction of arrival.

Such channel characteristics may be determined by either the access point 102 or the access terminal 104 according to various implementations described herein. The channel characteristics are generally determined using a sounding signal. In general, considering a MIMO system using multiple transmit and receive antennas, a channel may be modeled as y=Hx+n, where y represents the receive vector, x represents the transmit vector, H represents the channel matrix, and n represents the noise and interference vector. The noise and interference vector n is often modeled as circular symmetric complex normal with n˜CN (0, S), where the mean value is zero and the noise covariance matrix S is known. In at least one example, the channel characteristics may be determined using the expression vec(H)˜CN (vec(Hₑₛₜᵢₘₐₜₑ), Rₑᵣᵣₒᵣ), where Hₑₛₜᵢₘₐₜₑ is the channel estimate and Rₑᵣᵣₒᵣ is the estimation error covariance matrix. The vectorization vec( ) is used to achieve the column stacking of the channel matrix H. Employing the forgoing equations, the receiving device (e.g., access point 102 or access terminal 104) can measure a received sounding signal (e.g., a received acknowledgement frame, a dedicated sounding signal, etc.) that is previously known to the receiving device in order to estimate the channel matrix information using the combined knowledge of the transmitted and received sounding signal. By way of example and not limitation, the received sounding signal p is transmitted over the channel as y=Hp+n. Using a least-square estimator (also known as the minimum-variance unbiased estimator) to estimate one or more channel characteristics, the receiving device employs the equation H_{LS-estimate}=yp^{H}(pp^{H})⁻¹, where ( )^{H} denotes the conjugate transpose. In other implementations, for example when the channel and noise distributions are known, Bayesian estimation or minimum mean square error (MMSE) estimation may be employed.

Using channel sounding, the access point 102 is able to apply the correct adjustments to accurately form a beam directed at each particular access terminal 104 and to efficiently transmit data to the access terminal 104. Various features described herein relate to means for facilitating channel sounding in SDMA, MIMO or other similar transmissions between the access point 102 and the access terminals 104.

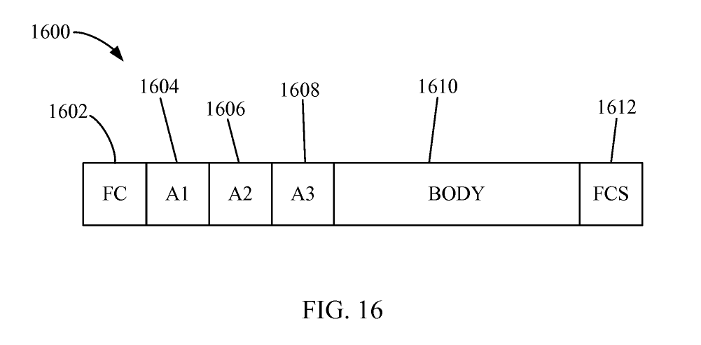

According to a feature, user datagram protocol (UDP) may be used for downlink transmission of the various data streams (e.g., video streams) from the access point 102 to the various access terminals 104. A UDP packet encapsulated as an IEEE 802.11 media access control (MAC) protocol data unit (MPDU) may be referred to as a UDP frame. An example of a conventional IEEE 802.11 frame is illustrated in FIG. 16. In general, an IEEE 802.11 transmission frame 1600 includes a frame control (FC) field 1602 indicating the frame type. A plurality of address fields, A1, A2 and A3, may be included. The first address field (A1) 1604 may indicate the broadcast address or the address of the intended receiver. The second address field (A2) 1606 may indicate the ID of the sender (e.g., the ID of the access point). The third address field (A3) 1608 may also include the sender's ID. The body 1610 of the transmission frame 1600 may include the specific data being transmitted for a data frame, or other information for other types of transmission frames. The transmission frame 1600 may conclude with a conventional frame check sequence (FCS) field 1612.

When user datagram protocol (UDP) is used for downlink transmission of some data streams (e.g., video streams), the only uplink traffic, or at least the substantial majority of uplink traffic, may be MAC-level acknowledgement messages. In addition, because there is little or no data transmitted in the uplink direction, there may be little or no MAC-level acknowledgements in the downlink direction.

According to a feature, the access point 102 may utilize the limited uplink traffic to facilitate channel sounding, where the access point 102 determines the channel characteristics (channel matrix information) for a channel between the access point 102 and an access terminal 104. In some implementations, an access terminal 104 periodically transmits an acknowledgement packet to the access point 102 using the same antennas it uses to receive transmissions from the access point 102, and with the same number of spatial streams as the access point 102 uses for SDMA transmissions to the access terminal 104. The access terminal 104 may accordingly need to have the same number of transmit chains (or transmit antennas) and receive chains (or receive antennas), which may add cost to the access terminal 104 if it functions primarily as a receiver. Such implementations where an uplink frame is employed as the sounding signal used by the access point 102 to determine the channel characteristics may be referred to as implicit feedback.

In other implementations, an access terminal 104 may periodically determine a channel and transmit the channel characteristics to the access point 102. In such implementations, the access terminal 104 may have fewer transmit antennas than receive antennas, which can reduce cost to the access terminals 104 relative to the multiple transmit antennas used for implicit feedback. Such implementations where channel matrix information is sent to the access point 102 may be referred to as explicit feedback.

When a new access terminal 104 joins the wireless communication system 100, the access point is typically unable to use SDMA transmissions to the new access terminal 104 right away. For instance, the access point 102 has no knowledge yet about the channel between the access point 102 and the new access terminal 104.

In implementations employing implicit feedback, the new access terminal 104 may first send a frame to the access point 102 with a preamble that uses as many spatial streams as the new access terminal 104 has receive antennas. The frame is transmitted to the access point 102 over the same antennas which will also be used to receive transmissions from the access point 102. Once the access point 102 receives such a frame, it can determine the channel to the new access terminal 104 and include new access terminal 104 in downlink SDMA transmissions from the access point 102. A sounding frame may be elicited by the access point 102 by sending a sounding request to the new access terminal 104. The access point 102 can use the sounding frame from the new access terminal to determine the channel characteristics (i.e., the channel matrix information).

In implementations employing explicit feedback, the new access terminal 104 may initially send a frame with a MIMO preamble using as many spatial streams as the access point 102 has transmit antennas. The data portion of the frame could be single-input multiple-output (SIMO), when the preamble contains extension long training field (LTF) symbols.

While certain features are described herein with reference to SDMA, those skilled in the art will recognize that such features may be generally applied in other similar technologies as well. In addition, while portions of the present disclosure will describe access terminals capable of communicating via SDMA, for certain aspects, the access terminals may also include some access terminals that do not support SDMA. Thus, for such aspects, an access point may be configured to communicate with both SDMA and non-SDMA capable access terminals. This approach may conveniently allow older versions of access terminals (“legacy” access terminals) to remain deployed in an enterprise, extending their useful lifetime, while allowing newer SDMA capable access terminals to be introduced as deemed appropriate. As used herein, the term “legacy” may generally refer to wireless network nodes (e.g., access terminal 104) that support IEEE 802.11n or earlier versions of the IEEE 802.11 standard (e.g., 802.11n, 802.11g, 802.11b, 802.11a, and 802.11).

### Exemplary Video Transmission Environment

Certain aspects of the present disclosure provide techniques for facilitating parallel transmissions as an SDMA transmission opportunity (SDMA TXOP). As noted above, the term SDMA transmission opportunities may cover other similar technologies as well. According to a feature, such parallel transmissions can be utilized in various applications involving video streams for conveying audio-video (AV) data. For example, multiple video streams can be distributed to multiple receivers in parallel. A video stream may be about 2 megabits per second (Mbps) for standard definition television (SDTV) using the MPEG-1 (moving picture expert group 1) compression standard, between about 8 to 25 Mbps for high definition television (HDTV) using the MPEG-2 compression standard, and about 54 Mbps for Blu-ray.

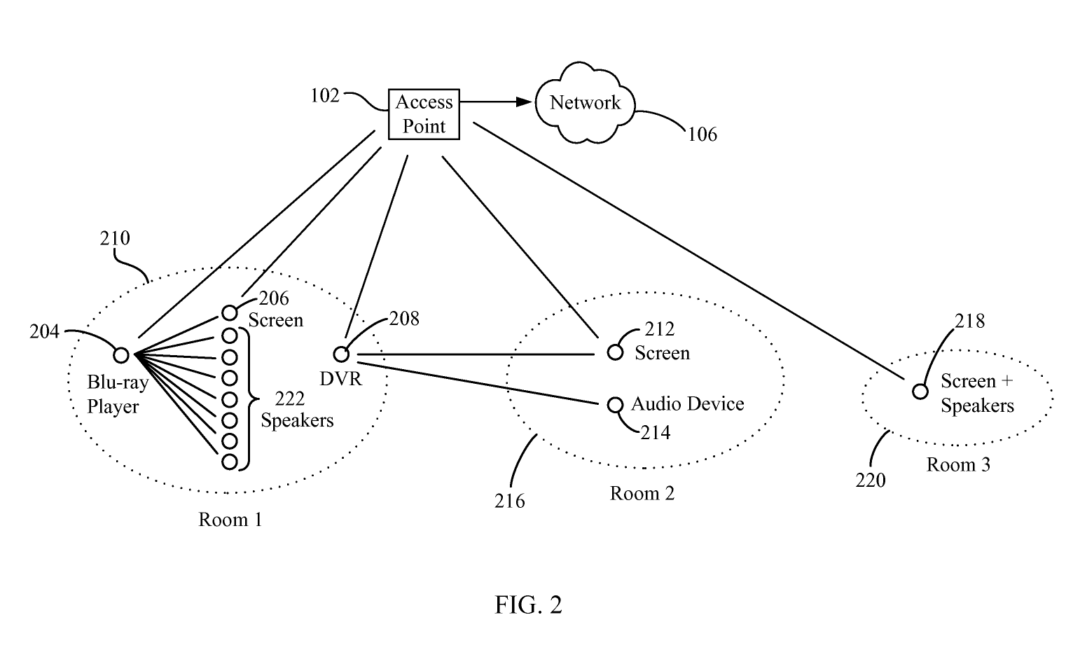

In various implementations of a wireless communication system (e.g., wireless communication system 100 of FIG. 1), such as in a home environment as illustrated in FIG. 2, video streams may be exchanged between several sources and destinations. As depicted in FIG. 2, an access point 102, illustratively shown with a connection to the communication network 106 (e.g., the internet), may stream media to various access terminals (e.g., access terminals 104) implemented as a variety of different devices and located in a variety of difference physical locations. For example, the access point 102 may stream media to a Blu-ray player 204, a monitor (screen) 206, and digital video recorder (DVR) 208 in a first room 210, a screen 212 and audio device 214 located in a second room 216, and a device 218 with integrated screen and speakers in a third room 220. The access point 102 may, for example, comprise a cable modem, a set-top box, a router, or the like.

In some cases, access terminals receiving streams from the access point 102 may also stream to various other access terminals. For example, the player 204 may stream to the screen 206 and speakers 222, the DVR may stream to screen 212 and audio device 214. Thus, certain access terminals may be both sources and receivers of video streams.

In some instances, multiple types of access terminals may be present in a single wireless communication system. For example, the screen 212 which receives the video image may have two receive antennas to allow faster throughput. But the audio device 214, which receives audio data, may only have a single antenna. In such cases, it is possible to use explicit feedback (e.g., where the access terminal sends the channel matrix information to access point) for the screen 212 and explicit feedback for the audio device 214, since a single receive antenna requires a single transmit antenna, which will always be present. Using explicit feedback for the screen 212 implies that the screen 212 may have more receive antennas than transmit antennas, which can reduce cost relative to the case of also having multiple transmit antennas for implicit feedback (e.g., where the access point determines the channel matrix information from an uplink frame from the access terminal).

### Facilitating Channel Sounding by Sending Uplink Packets Using the Same Antennas and Same Number of Spatial Streams Used to Receive Downlink Packets

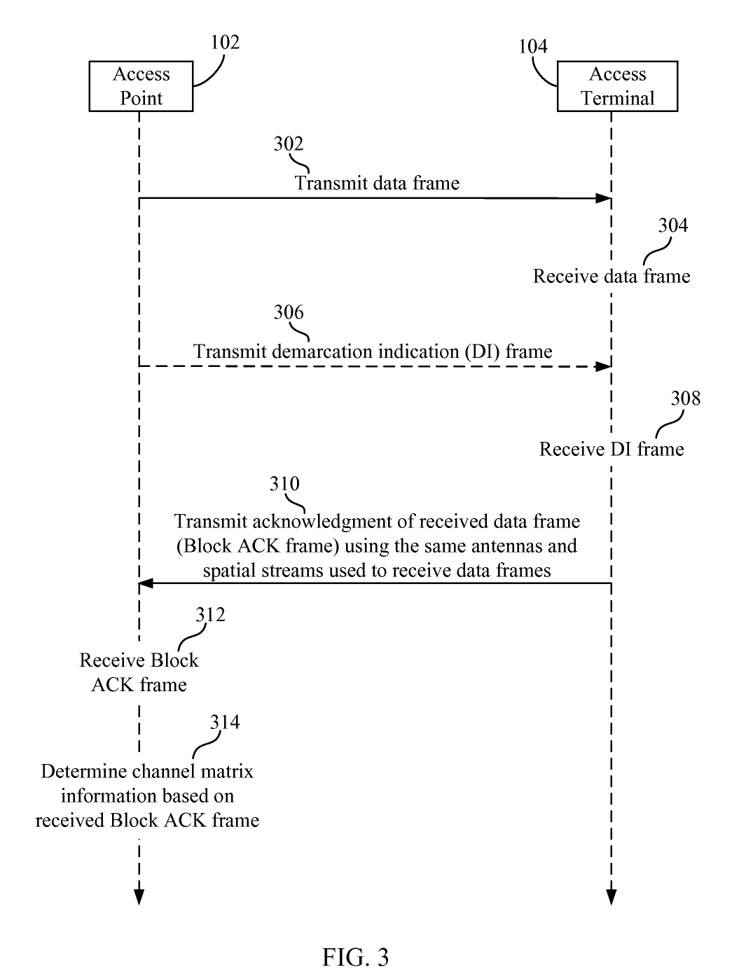

FIG. 3 is a flow diagram illustrating an example of a frame exchange between an access point and an access terminal for facilitating channel sounding using the same antennas and the same number of spatial streams to transmit an acknowledgement transmission from the access terminal. In this example, the access point 102 and an access terminal 104 of FIG. 1 are used for illustration purposes. The access point 102 may send a transmission to one or more access terminals 104, where the transmission includes one or more data frames (e.g., UDP frames transmitted as downlink data) 302. One of the data frames may be received 304 at the access terminal 104.

The transmission can be sent from the access point 102 via a spatial division multiple access (SDMA) scheme, where the access point 102 can send the transmission to the access terminal 104 using a single spatial stream or a plurality of spatial streams. For example, if the access point 102 employs only a single transmit antenna and/or if the access terminal 104 comprises only a single receive antennas, then the transmission is sent using only a single spatial stream. However, if the access point 102 employs two (or more) transmit antennas and the access terminal 104 comprises two (or more) receive antennas, then the access point 102 may send the transmission via two (or more) spatial streams (e.g., one spatial stream sent from each transmit antenna of the access point 102 to a respective receive antenna of the access terminal 104). As the data frame is received, the access terminal 104 may identify which antenna(s) is/are receiving the data frame transmission, and how many data streams are received in association with the data frame transmission to the access terminal 104.

The data carried by the data frames may include streaming video data. According to certain aspects, the data frames may be transmitted via one or more aggregated MAC protocol data units (A-MPDUs). The data frames may also specify an acknowledgement (ACK) policy. The acknowledgement (ACK) policy may contain information regarding how the received data frame is to be acknowledged by the access terminal 104.

In a SDMA scheme, uplink transmissions from multiple access terminals 104 to the access point 102 should be synchronized. Uplink transmissions should be synchronized in terms of arrival time at the access point 102, frequency, received power, length of packets, and allocation of spatial streams. The access point 102 may start uplink SDMA transmissions by sending a demarcation indication (DI) frame 306, which is received 308 by the access terminal 104. The demarcation indication frame specifies if and how the access terminal 104 may transmit during a pending uplink SDMA transmission opportunity. The uplink SDMA transmission opportunity starts at a fixed time interval after the demarcation indication frame. Resources inside a SDMA transmission opportunity may be requested by an access terminal 104 by sending an allocation indication (AI) frame (not shown), and the access point 102 may acknowledge an allocation indication (AI) frame by sending an allocation response (AR) frame (not shown). The demarcation indication frame and the data frames may be transmitted using various approaches. For example, the demarcation indication frame and data frames may be transmitted together via the same downlink A-MPDU or in separate downlink transmissions.

Although not shown in FIG. 3, it is noted that in other implementations, uplink transmissions from multiple access terminals 104 to the access point 102 may be serially transmitted in a sequential order. In such implementations, instead of sending a demarcation indication frame, the access point 102 may transmit a power save multi-poll (PSMP) frame (or some modification thereof), which specifies at least an uplink transmission time (UTT) for each addressed access terminal. The uplink transmission time (UTT) specifies the start time and duration of a sequential uplink transmission opportunity (TXOP) for each access terminal.

An acknowledgement for the previously received data frame may be sent by the access terminal 104 to the access point 102, in accordance with the information in the received DI frame, at a second transmission opportunity (e.g., an uplink transmission opportunity) 310. In the example depicted in FIG. 3, the access terminal 104 sends the acknowledgement frame using the same antennas it uses to receive transmissions from the access point 102, and with the same number of spatial streams as the access point 102 uses for SDMA transmissions to the access terminal 104. That is, after identifying which antenna(s) were employed to receive the data frame transmission, and the number of spatial streams employed to transmit the data frame, the access terminal 104 may employ the same number of antennas and the same number of spatial streams to send the acknowledgement frame. In this manner, the acknowledgement frame may be employed to acknowledge receipt of the data frame and as a sounding signal.

The access point 102 receives the acknowledgement frame 312 and uses the reception of the acknowledgement frame to determine the channel matrix information 314 for the access terminal 104. In other words, the access point 102 may measure one or more characteristics of the channel while receiving the acknowledgement frame, and may compare such characteristics to known characteristics of the acknowledgement frame as it originated from the access terminal 104 to generate data depicting the channel environment between the access point 102 and the access terminal 104. By using the same antennas and the same number of spatial streams in the uplink transmission by the access terminal 104, it can be presumed that the channel characteristics determined by the access point 102 are an accurate reflection of the channel characteristics in the downlink as well, possibly after having calibrated the channel in order to obtain knowledge about impairments between the uplink and the downlink channel. The access point 102 can therefore apply the correct adjustments to form a beam more efficiently directed at the access terminal 104.

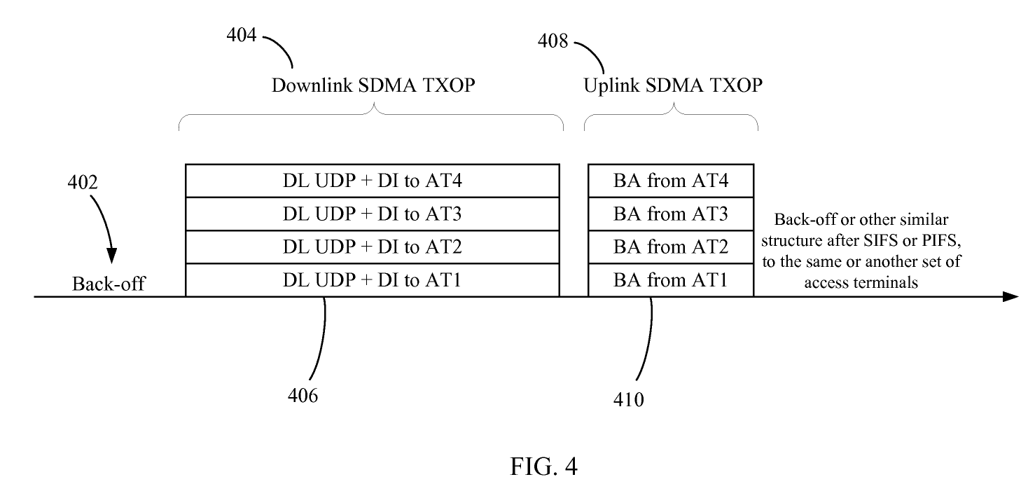

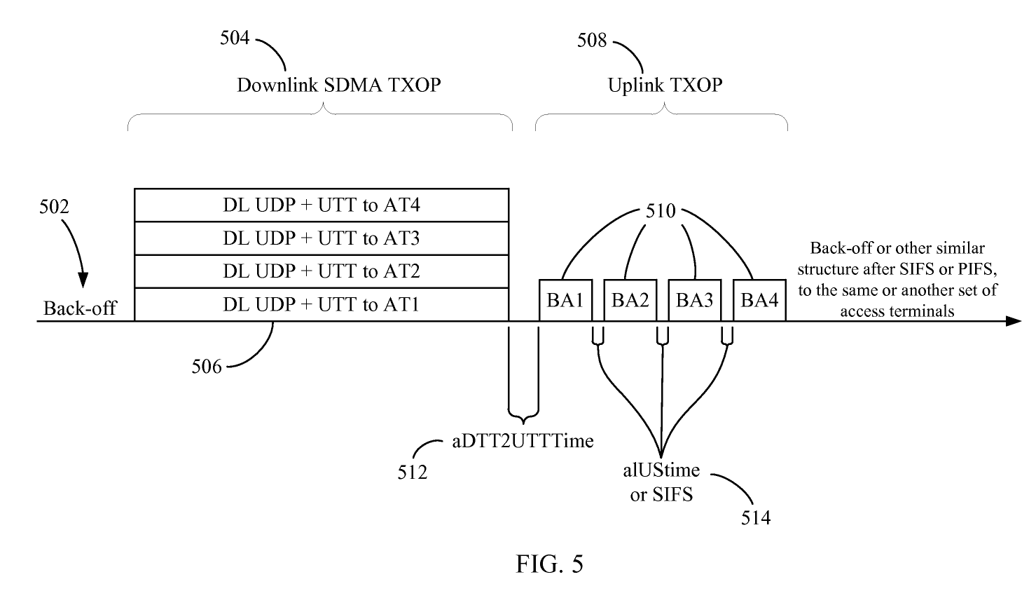

FIGS. 4 and 5 illustrate some non-limiting examples of transmission schemes between an access point and multiple access terminals where the access terminals transmit acknowledgement frames to the access point using the same antennas used to receive transmissions from the access point, and with the same number of spatial streams as the access point uses for SDMA transmissions to each access terminal. Components and/or elements involved in these examples may correspond to the components and/or elements of the systems illustrated in FIGS. 1, 2 and/or 3.

FIG. 4 is a block diagram illustrating an example of a transmission scheme between an access point (e.g., access point 102 of FIG. 1) and multiple access terminals (e.g., access terminals 104 of FIG. 1) including a SDMA downlink transmission and SDMA uplink transmissions. After a back-off period 402, the access point may start a downlink SDMA transmission opportunity (SDMA TXOP) 404. During the downlink SDMA transmission opportunity 404, the access point may transmit aggregated MAC protocol data units (A-MPDUs) 406 to access terminals (ATs) 1-4 in parallel. That is, the aggregated MAC protocol data units (A-MPDUs) 406 can be sent at least substantially concurrently to each access terminal (AT) 1-4.

As illustrated, the downlink A-MPDUs 406 can contain one or more downlink user datagram protocol (UDP) frames and a demarcation indication (DI) frame, which frame may be formatted similar to the transmission frame 1600 described herein above with reference to FIG. 16. According to a feature, the one or more UDP frames can contain video data. The demarcation indication frame may indicate the timing and the resource allocation of a pending uplink SDMA transmission opportunity (SDMA TXOP) 408. In the example of FIG. 4, the one or more UDP frames may specify an implicit block acknowledgement request (BAR) policy.

According to some implementations, high throughput (HT)-immediate block acknowledgements may be used to acknowledge the downlink UDP streams. High throughput (HT)-immediate block acknowledgement (HT-immediate BA) generally refers to a form of block acknowledgement (BA) in which the block acknowledgement frame is transmitted a short interframe space (SIFS) after the end of a received physical layer protocol data unit (PPDU) containing a block acknowledgement request (BAR) or an implicit block acknowledgement request. HT-immediate BA is further defined in the IEEE 802.11n standard, which is herein incorporated by reference in its entirety.

According to other implementations, high throughput (HT)-delayed block acknowledgements may be used to acknowledge the downlink UDP streams. High throughput (HT)-delayed block acknowledgement (HT-delayed BA) generally refers to a form of block acknowledgement (BA) in which the block acknowledgement frame is transmitted in the next transmission opportunity (TXOP) after the receipt of the physical layer protocol data unit (PPDU) containing a block acknowledgement request. HT-delayed BA is also further defined in the IEEE 802.11n standard. When HT-delayed BA is used, the block acknowledgements are sent in subsequent uplink transmission opportunities for the access terminals. The subsequent uplink transmission opportunities may be indicated by a demarcation indication (DI) as illustrated in FIG. 4, or the subsequent uplink transmission opportunities may be obtained after contention at the individual access terminals.

During the uplink SDMA transmission opportunity 408, the access terminals transmit an uplink A-MPDU 410 to the access point comprising one or more transmission frames, which may be formatted similar to the transmission frame 1600 described above. The uplink A-MPDUs 410 include the block acknowledgement (BA) frames to acknowledge receipt of the UDP frames, as effectively requested by the implicit block acknowledgement request in the downlink UDP frames. In this example, the uplink A-MPDUs 410 including the block acknowledgement frames are transmitted from the access terminals using the same antennas and spatial streams that are used to receive the downlink A-MPDU 406 from the access point so that the uplink A-MPDUs 410 can also be used as a sounding signal. The access point may determine channel matrix information for each access terminal based on the reception of the sounding signal (i.e., the uplink A-MPDU 410 with the block acknowledgement frames).

FIG. 5 is a block diagram illustrating an example of a transmission scheme between an access point (e.g., access point 102 of FIG. 1) and multiple access terminals (e.g., access terminals 104 of FIG. 1) including a SDMA downlink transmission and serial uplink transmissions. After a back-off period 502, the access point may start a downlink SDMA transmission opportunity (SDMA TXOP) 504. During the downlink SDMA transmission opportunity 504, the access point may transmit aggregated MAC protocol data units (A-MPDUs) 506 to access terminals (ATs) 1-4 in parallel (i.e., at least substantially concurrently).

As illustrated, the downlink A-MPDUs 506 can contain one or more downlink user datagram protocol (UDP) frames and an uplink transmission time (UTT). The various frames of the downlink A-MPDUs 506 may be formatted similar to the transmission frame 1600 described above with reference to FIG. 16. According to one feature, the one or more UDP frames can contain video data. The uplink transmission time (UTT) may specify the start time and duration of a sequential uplink transmission opportunity (TXOP) for each access terminal. The one or more UDP frames may specify a power save multi-poll (PSMP) acknowledgement (ACK) policy. The uplink transmission time (UTT) may comprise an action no ACK frame, so that no SIFS response will be elicited.

Because the uplink responses are scheduled sequentially, SDMA is not needed in the uplink direction in this example. This approach may be employed, for example, when one or more access terminals are not capable of SDMA transmissions.

Following the downlink SDMA transmission opportunity 504 during which the A-MPDUs 506 are transmitted, an uplink transmission opportunity (TXOP) 508 is provided. During the uplink transmission opportunity 508, each access terminal transmits an uplink A-MPDU 510 to the access point that includes the requested block acknowledgement (BA) frames to acknowledge receipt of the UDP frames. In this example, the uplink A-MPDU 510 including the block acknowledgement frames are transmitted from the access terminals using the same antennas and spatial streams that are used to receive the downlink A-MPDU 506 from the access point so that the uplink A-MPDUs 410 can also be used as a sounding signal. The access point may determine channel matrix information for each access terminal based on the reception of the sounding signal (i.e., the uplink A-MPDU 410 with the block acknowledgement frames).

The first uplink transmission may start some period of time (or interval) 512 after the downlink transmission opportunity 504. In some implementations, this interval may be a short interframe space (SIFS) (e.g., 16 microseconds (μs)). Each of the sequential uplink transmissions 510 may be separated by an interval 514 equal to aIUStime or SIFS. In implementations where reduced interface space (RIFS) is supported, this interval 514 may be a reduced interface space (RIFS) (e.g., 8 microseconds (μs)).

Facilitating Channel Sounding by Sending Channel Matrix Information from Each Access Terminal to the Access Point

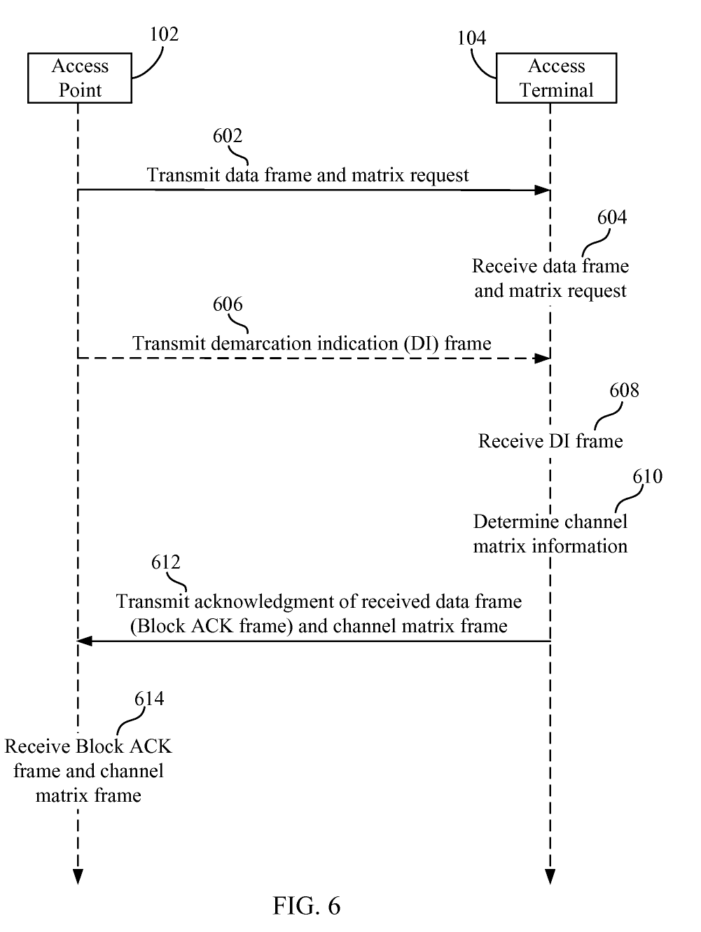

FIG. 6 is a flow diagram illustrating another example of a frame exchange between an access point and an access terminal for facilitating channel sounding using channel matrix information determined by the access terminal and sent to the access point. In this example, the access point 102 and an access terminal 104 of FIG. 1 are used for illustration purposes. The access point 102 may send a transmission to one or more access terminals 104, where the transmission includes one or more data frames (e.g., UDP frames transmitted as downlink data) as well as a matrix request frame 602. One of the data frames, together with the matrix request frame may be received 604 at the access terminal 104.

The data carried by the data frames may include streaming video data. According to certain aspects, the data frames may be transmitted via one or more aggregated MAC protocol data units (A-MPDUs). The data frames may also specify an acknowledgement (ACK) policy. The acknowledgement (ACK) policy may contain information regarding how the received data frame is to be acknowledged by the access terminal 104.

The matrix request frame may be adapted to ask for the access terminal 104 to return channel matrix information to the access point 102. That is, the matrix request frame may be adapted to instruct the access terminal 104 to determine the channel characteristics and to send the channel matrix information to the access point 102 for reporting the channel characteristics to the access point 102.

As noted above, uplink SDMA transmissions from multiple access terminals 104 to the access point 102 should be synchronized. The access point 102 may start uplink SDMA transmissions by sending a demarcation indication (DI) frame 606, which is received 608 by the access terminal 104. The demarcation indication frame specifies if and how the access terminal 104 may transmit during a pending uplink SDMA transmission opportunity. The uplink SDMA transmission opportunity starts at a fixed time interval after the demarcation indication frame. As will be illustrated below, the demarcation indication frame and the data frames may be transmitted using various approaches. For example, the demarcation indication frame and data frames may be transmitted together via the same downlink A-MPDU or in separate downlink transmissions.

Although not shown in FIG. 6, it is noted that in other implementations, uplink transmissions from multiple access terminals 104 to the access point 102 may be serially transmitted in a sequential order. In such implementations, the access point 102 may transmit a power save multi-poll (PSMP) frame (or some modification thereof), which specifies at least an uplink transmission time (UTT) for each addressed access terminal. The uplink transmission time (UTT) specifies the start time and duration of a sequential uplink transmission opportunity (TXOP) for each access terminal.

In response to the request from the access point 102, the access terminal 104 determines the channel matrix information 610. In other words, the access terminal 104 generates data depicting the channel environment between the access point 102 and the access terminal 104. The channel matrix information may comprise about 1 kilobyte (kB) of data, which is substantially larger than the typical acknowledgement frame.

An acknowledgement for the previously received data frame, together with the channel matrix information determined by the access terminal 104 may be sent to the access point 102, in accordance with the information in the received DI frame, at a second transmission opportunity (e.g., an uplink transmission opportunity) 612. In the example depicted in FIG. 6, the access terminal 104 can send the acknowledgement frame using fewer antennas than it uses to receive transmissions from the access point 102. This is because the access terminal 104 will be sending the channel matrix information to the access point 102, instead of the access point 102 determining the channel matrix information based on the received acknowledgement, as described in the other implementation depicted in FIG. 3.

The access point 102 receives the acknowledgement frame and the channel matrix information 614. The access point 102 may use the channel matrix information determined by the access terminal 104 to apply any needed adjustments to form a beam more efficiently directed at the access terminal 104.

Because of the relatively large size of the channel matrix information (about 1 kB), it may be desirable to reduce the frequency of such matrix requests to the access terminal 104. For instance, the access terminal 104 may need to send the channel matrix information to the access point 102 only about once every 10 milliseconds (ms). Therefore, the relative overhead of sending the channel matrix information may be reduced by requesting the channel matrix information only about once every 10 ms. The effective data rate of sending the channel matrices will therefore be in the order of about 1 megabit per second (Mbps) per access terminal 104, in the uplink direction. It should be noted that 10 ms is used herein only as a non-limiting example, and that the actual rate at which channel matrix information may need to be sent to the access point may be smaller or larger depending on how fast the channel characteristics are changing.

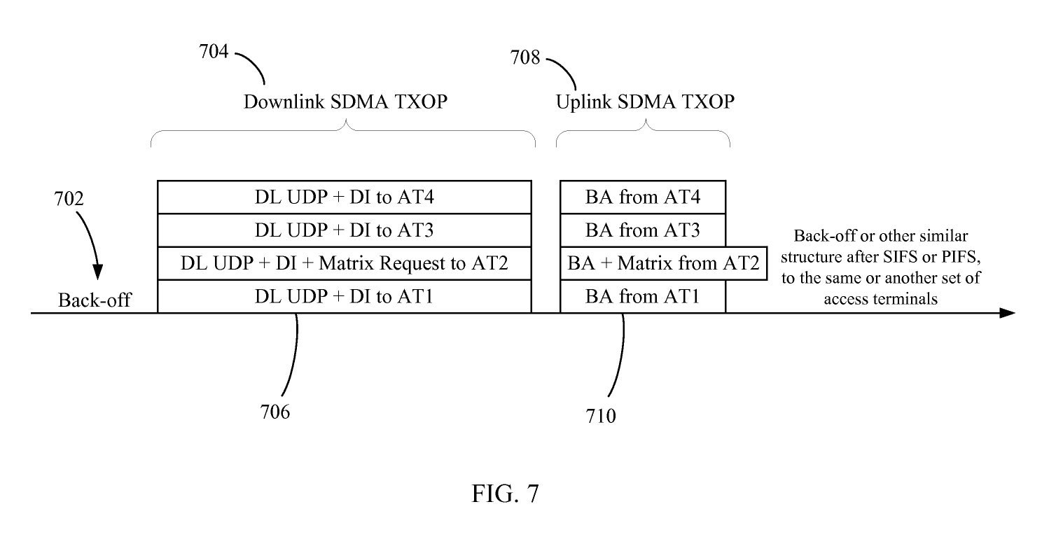

FIGS. 7-9 illustrate some non-limiting examples of transmission schemes between an access point and multiple access terminals where the access point transmits a matrix request to one or more access terminals, and the one or more access terminals respond by determining and sending respective channel matrix information to the access point. Components and/or elements involved in these examples may correspond to the components and/or elements of the systems illustrated in FIGS. 1, 2 and/or 6.

FIG. 7 is a block diagram illustrating an example of a transmission scheme between an access point (e.g., access point 102 of FIG. 1) and multiple access terminals (e.g., access terminals 104 of FIG. 1) including a SDMA downlink transmission and SDMA uplink transmissions. After a back-off period 702, the access point may start a downlink SDMA transmission opportunity (SDMA TXOP) 704. During the downlink SDMA transmission opportunity 704, the access point may transmit aggregated MAC protocol data units (A-MPDUs) 706 to access terminals (ATs) 1-4 in parallel (i.e., at least substantially concurrently).

As illustrated, the downlink A-MPDUs 706 can contain various frames, such as one or more downlink user datagram protocol (UDP) frames and a demarcation indication (DI) frame. In addition to the UDP frame and the DI frame, one or more of the downlink A-MPDUs 706 also includes a matrix request frame. According to a feature, the one or more UDP frames can contain video data. The demarcation indication may indicate the timing and the resource allocation of a pending uplink SDMA transmission opportunity (SDMA TXOP) 708. The matrix request frame is a request for channel matrix information to be returned to the access point by the receiving access terminal. The various frames of the downlink A-MPDUs 706 may be generally formatted similar to the transmission frame 1600 described above with reference to FIG. 16.

In the example of FIG. 7, the one or more UDP frames may specify an implicit block acknowledgement request (BAR) policy. According to some implementations, high throughput (HT)-immediate block acknowledgements (HT-immediate BA) may be used to acknowledge the downlink UDP streams. In other implementations, high throughput (HT)-delayed block acknowledgements may be used to acknowledge the downlink UDP streams. In this case, the UDP frames may specify a block acknowledgement policy, indicating that the block acknowledgements be sent in the next transmission opportunity for the access device. The next transmission opportunity may be an uplink SDMA transmission opportunity indicated by a demarcation indication (DI) frame that is sent by the access point (AP).

During the uplink SDMA transmission opportunity 708, the access terminals transmit an A-MPDU 710 to the access point. The uplink A-MPDU 710 can include the block acknowledgement (BA) frames to the access point to acknowledge receipt of the UDP frames, as effectively requested by the implicit block acknowledgement request on the downlink UDP frames. Additionally, for those access terminals that received a matrix request frame, the A-MPDU 710 also includes a channel matrix information frame that indicates the channel matrix information for the channel between the access point's transmit antennas and the access terminal's receive antennas. In such implementations, the uplink A-MPDUs 710 can be transmitted from the access terminals using less antennas and/or less spatial streams than were used to receive the downlink A-MPDU 706 from the access point. The various frames of the uplink A-MPDUs 710 may be generally formatted similar to the transmission frame 1600 described above with reference to FIG. 16.

According to various implementations, the access point may arrange the matrix requests so that all access terminals respond with respective channel matrix information during the same SDMA uplink transmission opportunity 708, followed by a number of transmission opportunities without transmission of any matrix requests or channel matrices. Such a scheme may be more efficient than adding only one or a few matrix requests per downlink SDMA transmission opportunity 704, since the duration of the uplink SDMA transmission opportunities 708 will be determined by the uplink frame which contains the channel matrix information (due to the size of the channel matrix).

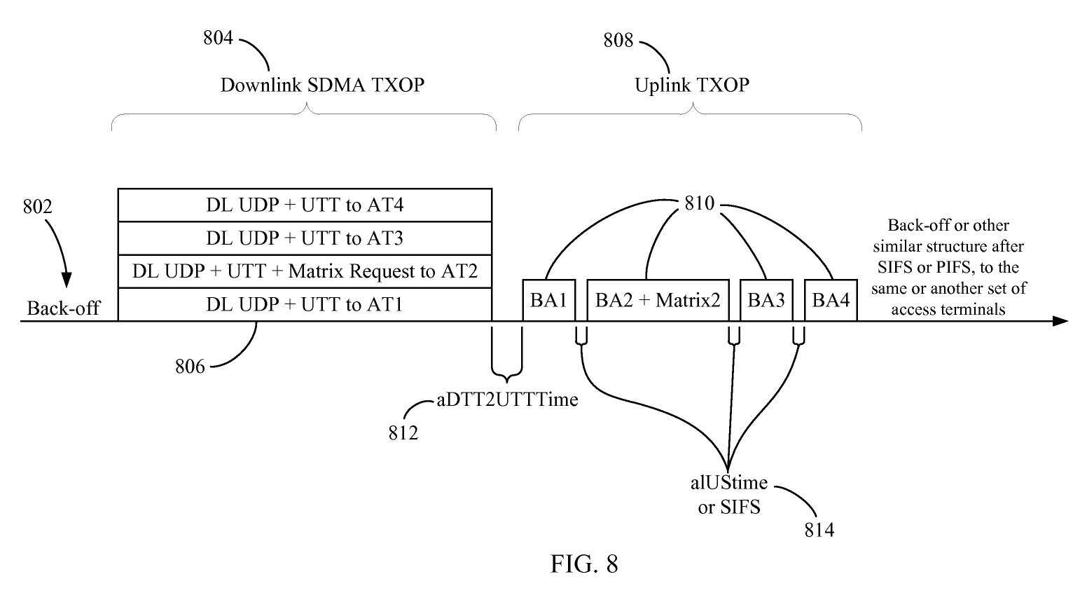

FIG. 8 is a block diagram illustrating an example of a transmission scheme between an access point (e.g., access point 102 of FIG. 1) and multiple access terminals (e.g., access terminals 104 of FIG. 1) including a SDMA downlink transmission and serial uplink transmissions. After a back-off period 802, the access point may start a downlink SDMA transmission opportunity (SDMA TXOP) 804. During the downlink SDMA transmission opportunity 804, the access point may transmit aggregated MAC protocol data units (A-MPDUs) 806 to access terminals (ATs) 1-4 in parallel (i.e., at least substantially concurrently).

As illustrated, the downlink A-MPDUs 806 can contain various frames, generally formatted similar to the transmission frame 1600 described above with reference to FIG. 16. For example, the downlink A-MPDUs 806 may include frames such as one or more downlink user datagram protocol (UDP) frames and an uplink transmission time (UTT). In addition, at least one of the downlink A-MPDUs 806 includes a matrix request frame. According to one feature, the one or more UDP frames can contain video data. The uplink transmission time (UTT) may specify the start time and duration of a sequential uplink transmission opportunity (TXOP) 808 for each access terminal. The one or more UDP frames may specify a power save multi-poll (PSMP) acknowledgement (ACK) policy, to be used to acknowledge the downlink UDP streams. The uplink transmission time (UTT) frame may comprise an action no ACK frame, so that no SIFS response will be elicited. The matrix request frame is a request for channel matrix information to be returned to the access point from the respective receiving access terminal.

Because the uplink responses are scheduled sequentially, SDMA is not needed in the uplink direction. This approach may be employed, for example, when one or more access terminals are not capable of SDMA transmissions.

Following the downlink SDMA transmission opportunity 804 including the A-MPDUs 806, an uplink transmission opportunity (TXOP) 808 is provided. During the uplink transmission opportunity 808, each access terminal transmits an A-MPDU 810 to the access point. The respective uplink A-MPDUs 810 can include the requested block acknowledgement (BA) frames to acknowledge receipt of the UDP frames. In addition, any access terminal that received a matrix request frame will also include with the uplink A-MPDU 810, a channel matrix information frame that indicates the channel matrix information, as determined by the access terminal. In such implementations, the block acknowledgement frames and any channel matrix information frames can be transmitted from the access terminals using fewer antennas and/or spatial streams than what are used to receive the downlink A-MPDU from the access point. The various frames in the uplink A-MPDU 810 may be generally formatted similar to the transmission frame 1600 described above. The access point may use the received channel matrix information for efficiently sending downlink SDMA transmissions to the respective access terminals.

The first uplink transmission may start some period of time (or interval) 812 after the downlink transmission opportunity 804. In practice, this interval may be a short interframe space (SIFS) (e.g., 16 microseconds (μs)). Each of the sequential uplink transmissions 810 may be separated by an interval 814 equal to aIUStime or SIFS. In implementations where reduced interface space (RIFS) is supported, this interval 814 may be a reduced interface space (RIFS) (e.g., 8 microseconds (μs)).

As noted above, a channel matrix information frame may only need to be sent from each access terminal to the access point about once every 10 milliseconds (ms). Therefore, an access terminal may be adapted to send most uplink A-MPDUs 810 with only a block acknowledgement frame and without a channel matrix information frame. Each access terminal may only need to provide a channel matrix information frame with the uplink A-MPDUs 810 only about once every 10 ms.

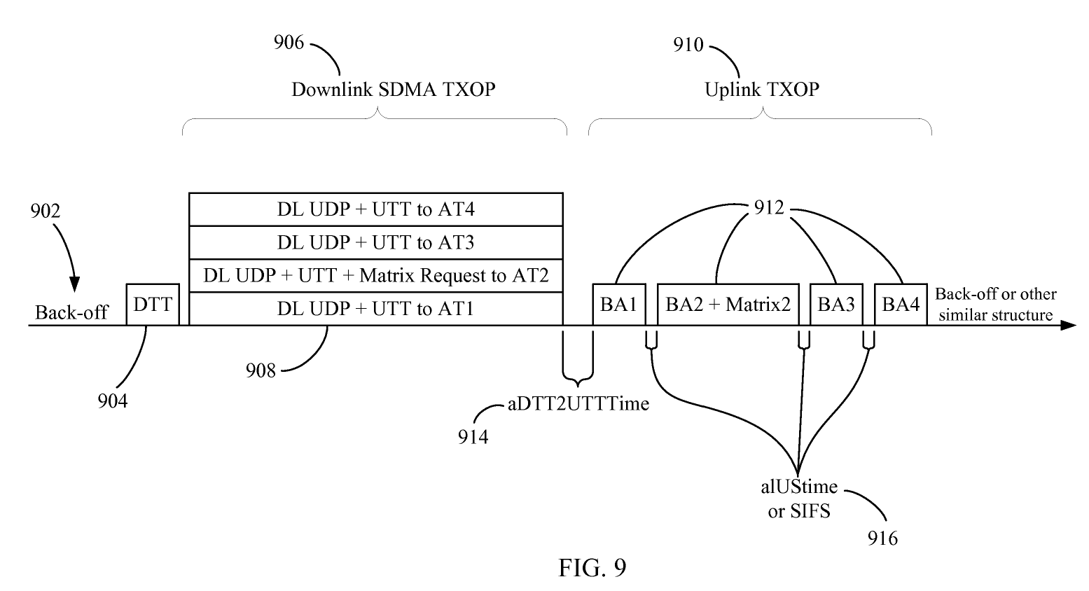

FIG. 9 is a block diagram illustrating another example of a transmission scheme between an access point (e.g., access point 102 of FIG. 1) and multiple access terminals (e.g., access terminals 104 of FIG. 1) including a SDMA downlink transmission and serial uplink transmissions. After a back-off period 902, the access point may send a downlink transmission time (DTT) frame 904 specifying a downlink SDMA transmission opportunity (TXOP) 906. The DTT frame 904 may set a network allocation vector (NAV) to protect the pending downlink SDMA transmission opportunity 906. The DTT frame 904 can indicate which access terminals will be receiving data during the downlink SDMA transmission opportunity 906. Access terminals that are not included in the DTT frame 904 can enter a sleep mode for the duration of the following uplink transmission sequence, or until the scheduled occurrence of a next uplink transmission sequence.

In some implementations, the downlink and uplink times may be specified in a single frame, using the conventional power save multi-poll (PSMP) frame. In this case, the PSMP frame is transmitted instead of the DTT frame. Also, the UTT frames in each downlink A-MPDU are no longer present. Power save multi-poll (PSMP) generally refers to a channel access method which is described in the IEEE 802.11n standard. In general, power save multi-poll (PSMP) starts with a PSMP frame transmitted by the access point, which specifies for each addressed access terminal a downlink transmission time (DTT) and an uplink transmission time (UTT), respectively. The acknowledgement (ACK) policy on data frames transmitted using PSMP is PSMP ACK, which is a form of HT-immediate BA, but with the additional requirement that the block acknowledgement is not transmitted a short interframe space (SIFS) after the end of reception of the physical layer protocol data unit (PPDU), but during a scheduled uplink or downlink time slot.

In other implementations, the DTT frame 904 may be a modified version of the conventional power save multi-poll (PSMP) frame, where the modification allows downlink transmission times to overlap and where the uplink transmission times (UTT) are removed from the frame.

Following the DTT frame 904, the access point may start the scheduled downlink SDMA transmission opportunity (SDMA TXOP) 906. In at least some implementations, the downlink SDMA transmission opportunity 906 may be separated from the DTT frame 904 by a reduced interface space (RIFS). During the downlink SDMA transmission opportunity 906, the access point may transmit aggregated MAC protocol data units (A-MPDUs) 908 to access terminals (ATs) 1-4 in parallel (i.e., at least substantially concurrently).

As illustrated, the downlink A-MPDUs 908 can contain one or more downlink user datagram protocol (UDP) frames and an uplink transmission time (UTT). In addition, at least one of the downlink A-MPDUs 908 includes a matrix request. According to one feature, the one or more UDP frames can contain video data. The uplink transmission time (UTT) may specify the start time and duration of a sequential uplink transmission opportunity (TXOP) 910 for each access terminal. The one or more UDP frames may specify a power save multi-poll (PSMP) acknowledgement (ACK) policy, to be used to acknowledge the downlink UDP streams. The matrix request is a request for channel matrix information to be returned to the access point from the respective receiving access terminal.

Following the downlink SDMA transmission opportunity 906 including the A-MPDUs 908, an uplink transmission opportunity (TXOP) 910 is provided. During the uplink transmission opportunity 910, each access terminal transmits an A-MPDU 912 to the access point. The respective uplink A-MPDUs 912 can include the requested block acknowledgement (BA) frames to acknowledge receipt of the UDP frames. In addition, any access terminal that received a matrix request frame will also include with the uplink A-MPDU 912, a channel matrix information frame as determined by the access terminal. In such implementations, the block acknowledgement frames and any channel matrix information frames can be transmitted from the access terminals using fewer antennas and/or spatial streams than what are used to receive the downlink A-MPDU from the access point. The access point may use the channel matrix information for efficiently sending downlink SDMA transmissions to the respective access terminals. In the forgoing description of FIG. 9, the various frames may be formatted similar to the transmission frame 1600 described herein above with reference to FIG. 16.

The first uplink transmission may start some period of time (or interval) 914 after the downlink transmission opportunity 906. In practice, this interval may be a short interframe space (SIFS) (e.g., 16 microseconds (μs)). Each of the sequential uplink transmissions 910 may be separated by an interval 916 equal to aIUStime or SIFS. In implementations where reduced interface space (RIFS) is supported, this interval 916 may be a reduced interface space (RIFS) (e.g., 8 microseconds (μs)).

As noted above, a channel matrix information frame may only need to be sent from each access terminal to the access point about once every 10 milliseconds (ms). Therefore, an access terminal may be adapted to send most block acknowledgement frames without a channel matrix information frame, and may include a channel matrix information frame with the uplink A-MPDUs 912 only about once every 10 ms.

### Exemplary Access Terminal

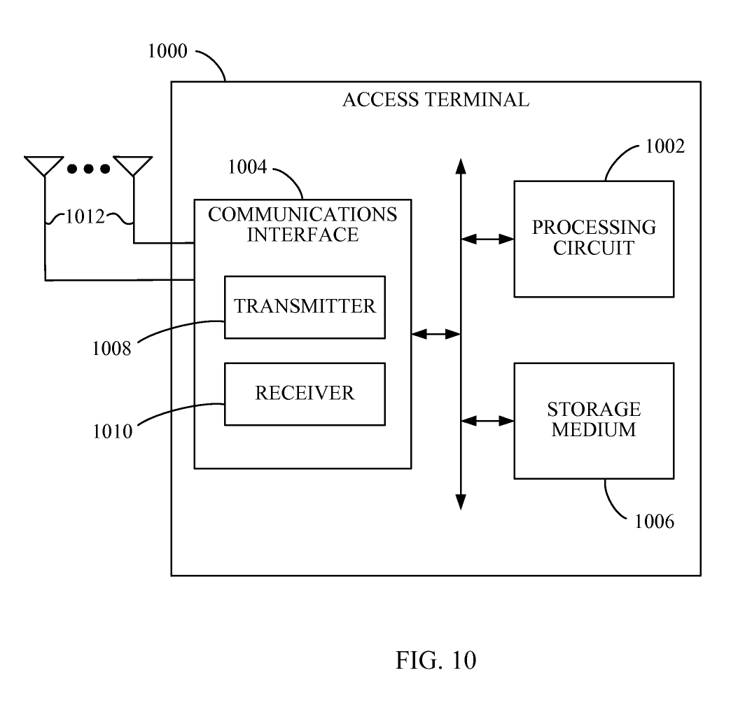

FIG. 10 is a block diagram illustrating select components of an access terminal 1000 according to at least one implementation. The access terminal 1000 may include a processing circuit 1002 coupled to a communications interface 1004 and to a storage medium 1006.

The processing circuit 1002 is arranged to obtain, process and/or send data, control data access and storage, issue commands, and control other desired operations. The processing circuit 1002 may comprise circuitry configured to implement desired programming provided by appropriate media in at least one embodiment. For example, the processing circuit 1002 may be implemented as one or more of a processor, a controller, a plurality of processors and/or other structure configured to execute executable instructions including, for example, software and/or firmware instructions, and/or hardware circuitry. Embodiments of the processing circuit 1002 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor but, in the alternative, the processor may be any conventional processor, controller, microcontroller, or state machine. A processor may also be implemented as a combination of computing components, such as a combination of a DSP and a microprocessor, a number of microprocessors, one or more microprocessors in conjunction with a DSP core, or any other such configuration. These examples of the processing circuit 1002 are for illustration and other suitable configurations within the scope of the present disclosure are also contemplated.

The communications interface 1004 is configured to facilitate wireless communications of the access terminal 1000. The communications interface 1004 may include at least one transmitter 1008 and/or at least one receiver 1010 (e.g., one or more transmitter/receiver chains). Furthermore, one or more antennas 1012 may be electrically coupled to each transmitter 1008 and/or receiver 1010 of the communications interface 1004. The access terminal 1000 may be equipped with a single antenna 1012 (e.g., in order to keep costs down) or multiple antennas 1012 (e.g., where the additional cost can be supported). According to at least some embodiments, the access terminal 1000 includes a plurality of receive antennas (i.e., antennas 1012 coupled to a respective receiver 1010 of a plurality of receivers 1010) and a plurality of transmit antennas (i.e., antennas 1012 coupled to a respective transmitter 1008 of a plurality of transmitters 1008). According to a feature, the access terminal 1000 can include the same number of receive antennas 1012 as it has transmit antennas 1012.

The storage medium 1006 may represent one or more devices for storing programming and/or data, such as processor executable code or instructions (e.g., software, firmware), electronic data, databases, or other digital information. The storage medium 1006 may be any available media that can be accessed by a general purpose or special purpose processor. By way of example and not limitation, the storage medium 1006 may include read-only memory (e.g., ROM, EPROM, EEPROM), random access memory (RAM), magnetic disk storage mediums, optical storage mediums, flash memory devices, and/or other non-transitory computer-readable mediums for storing information. The storage medium 1006 may be coupled to the processing circuit 1002 such that the processing circuit 1002 can read information from, and write information to, the storage medium 1006. In the alternative, the storage medium 1006 may be integral to the processing circuit 1002.

According to one or more features, the processing circuit 1002 may be adapted to perform any or all of the processes, functions, steps and/or routines related to the various access terminals as described herein above with reference to FIGS. 1-9 (e.g., access terminal 104, AT1, AT2, AT3 and/or AT4). As used herein, the term “adapted” in relation to the processing circuit 1002 may refer to the processing circuit 1002 being one or more of configured, employed, implemented, or programmed to perform a particular process, function, step and/or routine according to various features.

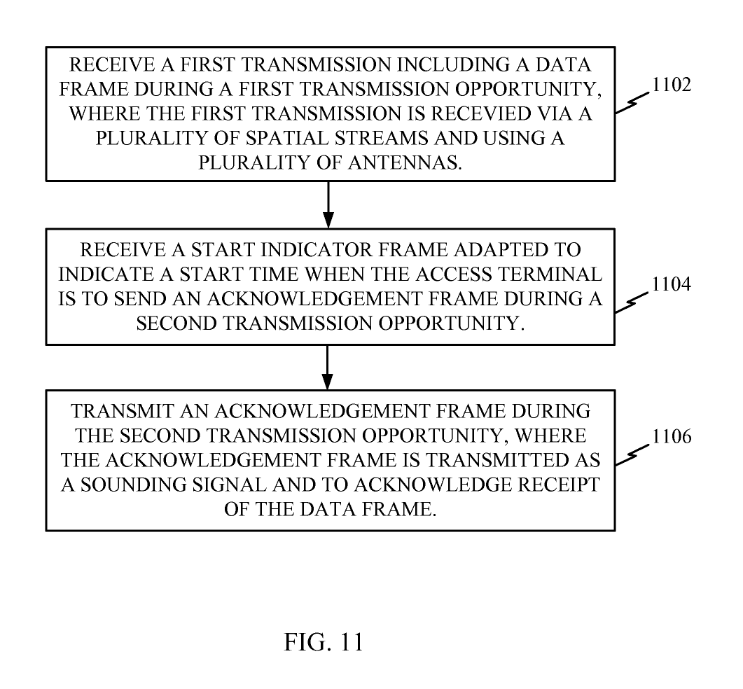

FIG. 11 is a flow diagram illustrating an example of at least one implementation of a method operational on an access terminal, such as the access terminal 1000. With reference to both of FIGS. 10 and 11, a first transmission (e.g., in the downlink direction) may be received during a first transmission opportunity at step 1102. The first transmission includes a data frame. The received data frame can be implemented as a user datagram protocol (UDP) frame. According to a feature, the data frame may comprise streaming video data.

The first transmission is received via a plurality of spatial streams and using a plurality of antennas 1012 of the communications interface 1004. For example, the first transmission may be received by the processing circuit 1002 via a plurality of the antennas 1012 of the communications interface 1004. In some implementations, the first transmission may be received via a spatial division multiple access (SDMA) scheme.

A start indicator frame may optionally be received 1104 with, for example, the first transmission sent during the first transmission opportunity. The start indicator frame is adapted to indicate a start time when the access terminal 1000 is to send an acknowledgement frame during a second transmission opportunity. For example, the start indicator frame can comprise a demarcation indication (DI) frame or an uplink transmission time (UTT) frame.

The access terminal transmits an acknowledgement frame during the second transmission opportunity at step 1106. The acknowledgement frame is transmitted as both a sounding signal and as an acknowledgement of receipt of the data frame. The acknowledgement frame is transmitted using the same spatial streams and antennas that are used to receive the first transmission. For example, the processing circuit 1002 may identify the spatial streams and the antennas employed to receive the first transmission at step 1102, and may then send the acknowledgement frame using the same spatial streams and antennas 1012 of the communications interface 1004 used to receive the first transmission. The acknowledgement frame may be sent concurrently with an acknowledgement frame transmitted by at least one other access terminal (e.g., via a SDMA scheme), or the acknowledgement frame may be sent in a sequential order with an acknowledgement frame transmitted by one or more other access terminals.

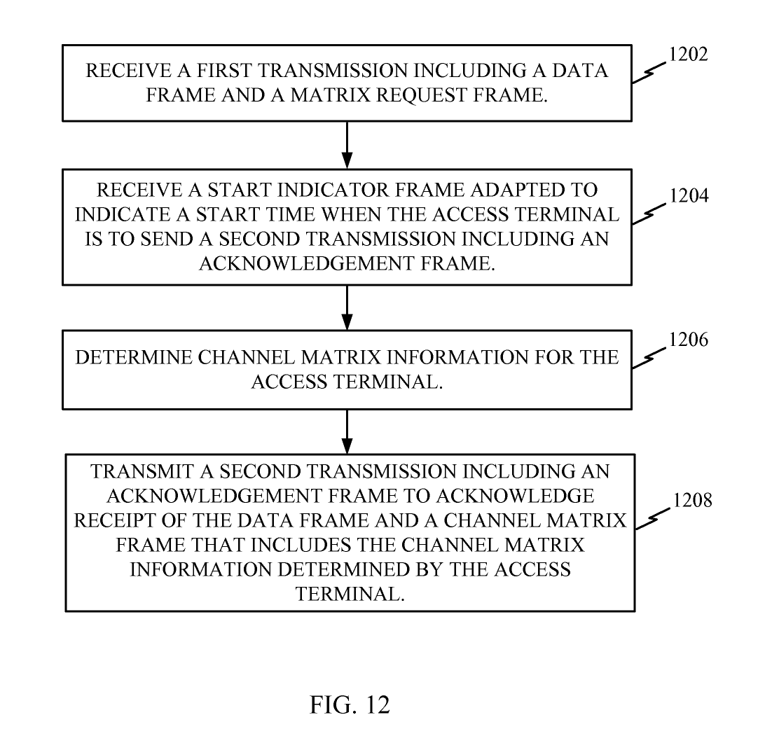

FIG. 12 is a flow diagram illustrating another example of at least one implementation of a method operational on an access terminal, such as the access terminal 1000. With reference to both of FIGS. 10 and 12, a first transmission (e.g., in the downlink direction) is received at step 1202. For example, the processing circuit 1002 may be adapted to receive the first transmission via the communications interface 1004. The first transmission includes a data frame and a matrix request frame. The data frame may comprise a user datagram protocol (UDP) frame. The data frame may be transmitted including streaming video data.

The first transmission may be received via a plurality of spatial streams and using a plurality of antennas 1012 of the communications interface 1004. In some implementations, the first transmission may be received via a spatial division multiple access (SDMA) scheme.

A start indicator frame may also be received with the first transmission at optional step 1204. The start indicator frame is adapted to indicate a start time when the access terminal 1000 is to send an acknowledgement frame during a second transmission opportunity. For example, the start indicator frame can comprise a demarcation indication (DI) frame or an uplink transmission time (UTT) frame.

Upon receipt of the first transmission including the matrix request frame, the access terminal 1000 may determine channel matrix information at step 1206. For example, the processing circuit 1002 may measure a received sounding signal that is known to the access terminal 1000 to ascertain one or more characteristics of the channel environment between an access point and the access terminal 1000, and can generate data depicting that channel environment. That is, the processing circuit 1002 may monitor received sounding signal(s) (e.g., the received first transmission or a signal sent specifically for channel sounding) and may measure the received signal(s) to determine or estimate the channel state information for the channel. In at least some implementations, the processing circuit 1002 may measure the known signal and generate data depicting the one or more channel characteristics using a least-square estimation, a Bayesian estimation, a minimum mean square error (MMSE) estimation, etc. The processing circuit 1002 may employ such calculations to the measured signal to determine or estimate one or more channel characteristics, such as interference levels, signal strength, noise floors, direction of departure, direction of arrival, etc.

With the channel matrix information generated, the access terminal 1000 can send a second transmission at step 1208. For example, the processing circuit 1002 may be adapted to send the second transmission via the communications interface 1004. The second transmission includes an acknowledgement frame to acknowledge receipt of the data frame, and a channel matrix information frame that includes the channel matrix information determined by the access terminal 1000. The second transmission may be sent concurrently with an acknowledgement frame transmitted by at least one other access terminal, or the second transmission may be sent in a sequential order with an acknowledgement frame transmitted by one or more other access terminals.

### Exemplary Access Point

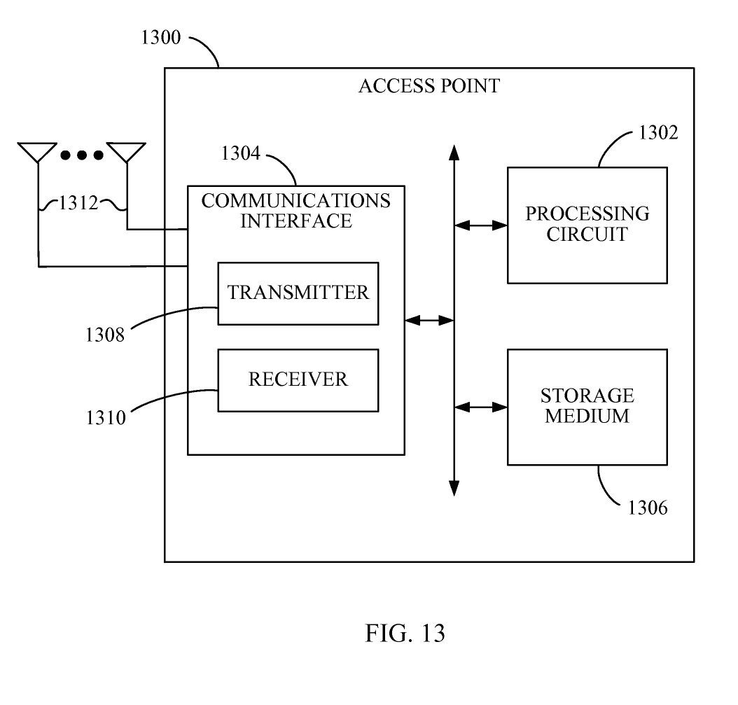

FIG. 13 is a block diagram illustrating select components of an access point according to at least one implementation. As shown, an access point 1300 may include a processing circuit 1302 coupled to a communications interface 1304 and to a storage medium 1306.

The processing circuit 1302 is arranged to obtain, process and/or send data, control data access and storage, issue commands, and control other desired operations. The processing circuit 1302 may comprise circuitry configured to implement desired programming provided by appropriate media in at least one embodiment. For example, the processing circuit 1302 may be implemented as one or more of a processor, a controller, a plurality of processors and/or other structure configured to execute executable instructions including, for example, software and/or firmware instructions, and/or hardware circuitry. Embodiments of the processing circuit 1302 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor but, in the alternative, the processor may be any conventional processor, controller, microcontroller, or state machine. A processor may also be implemented as a combination of computing components, such as a combination of a DSP and a microprocessor, a number of microprocessors, one or more microprocessors in conjunction with a DSP core, or any other such configuration. These examples of the processing circuit 1302 are for illustration and other suitable configurations within the scope of the present disclosure are also contemplated.

The communications interface 1304 is configured to facilitate wireless communications of the access point 1300. The communications interface 1304 may include at least one transmitter 1308 and/or at least one receiver 1310 (e.g., one or more transmitter/receiver chains). Furthermore, one or more antennas 1312 may be electrically coupled to the communications interface 1304. According to at least some embodiments, the access point 1300 includes a plurality of receive antennas (i.e., antennas 1312 coupled to a respective receiver 1310 of a plurality of receivers 1310) and a plurality of transmit antennas (i.e., antennas 1312 coupled to a respective transmitter 1308 of a plurality of transmitters 1308). According to a feature, the access point 1300 can include the same number of receive antennas 1312 as it has transmit antennas 1312.

The storage medium 1306 may represent one or more devices for storing programming and/or data, such as processor executable code or instructions (e.g., software, firmware), electronic data, databases, or other digital information. The storage medium 1306 may be any available media that can be accessed by a general purpose or special purpose processor. By way of example and not limitation, the storage medium 1306 may include read-only memory (e.g., ROM, EPROM, EEPROM), random access memory (RAM), magnetic disk storage mediums, optical storage mediums, flash memory devices, and/or other non-transitory computer-readable mediums for storing information. The storage medium 1306 may be coupled to the processing circuit 1302 such that the processing circuit 1302 can read information from, and write information to, the storage medium 1306. In the alternative, the storage medium 1306 may be integral to the processing circuit 1302.

According to one or more features, the processing circuit 1302 may be adapted to perform any or all of the processes, functions, steps and/or routines related to the various access points as described herein above with reference to FIGS. 1-9 (e.g., access point 102). As used herein, the term “adapted” in relation to the processing circuit 1302 may refer to the processing circuit 1302 being one or more of configured, employed, implemented, or programmed to perform a particular process, function, step and/or routine according to various features.

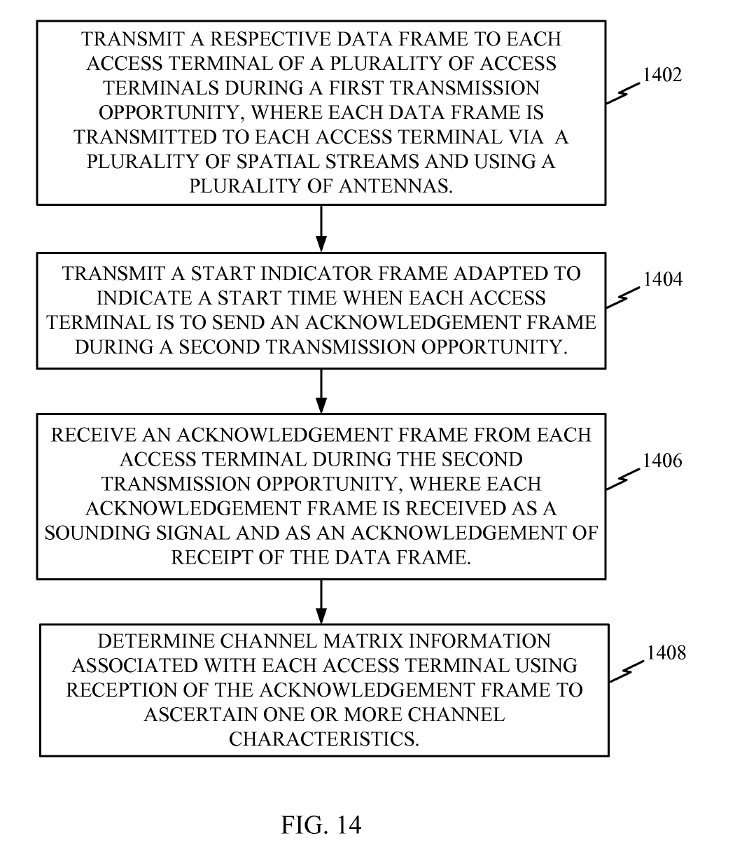

FIG. 14 is a flow diagram illustrating an example of at least one implementation of a method operational on an access point, such as access point 1300. With reference to both of FIGS. 13 and 14, the access point 1300 may transmit a respective data frame to each access terminal of a plurality of access terminals during a first transmission opportunity 1402. Each data frame can be implemented as a user datagram protocol (UDP) frame. In addition, at least some of the data frame may comprise streaming video data.

The first transmission is transmitted via a plurality of spatial streams and using a plurality of antennas 1312 of the communications interface 1304. For example, the first transmission may be transmitted by the processing circuit 1302 via the plurality of transmit antennas 1312 of the communications interface 1304. In some implementations, the respective data frame may be transmitted to each access terminal via a spatial division multiple access (SDMA) scheme.

A start indicator frame may optionally be transmitted 1404 with, for example, the data frame sent during the first transmission opportunity. The start indicator frame is adapted to indicate a start time when each access point 1300 is to send an acknowledgement frame during a second transmission opportunity. For example, the start indicator frame can comprise a demarcation indication (DI) frame or an uplink transmission time (UTT) frame.

The access point 1300 receives an acknowledgement frame from each of the access terminals during the second transmission opportunity at step 1406, where each acknowledgement frame is received as both a sounding signal and as an acknowledgement of receipt of the data frame. For example, the processing circuit 1302 may receive the acknowledgement frame via the communications interface 1304. In at least some implementations, the processing circuit 1302 may receive the acknowledgement frame using the same spatial streams and antennas 1312 of the communications interface 1304 used to transmit the first transmission to the plurality of access terminals. The acknowledgement frames may be received concurrently from each access terminal during the second transmission opportunity (e.g., via a SDMA scheme). In other implementations, the acknowledgement frames may be received from each access terminal in a sequential order during the second transmission opportunity.

Employing the receipt of the acknowledgement frames from each access terminal, the access point 1300 determines channel matrix information associated with each access terminal at step 1408. As noted herein above, the acknowledgement frames can be determined by some preselected acknowledgement policy. Because the format of the acknowledgement frames are generally known to the access point 1300, the acknowledgement frames can also be employed as a sounding signal and the access point 1300 can employ reception of these acknowledgement frames to determine the channel matrix information associated with each access terminal. For example, the processing circuit 1302 may measure a signal associated with the received acknowledgement frame, and may estimate one or more characteristics using least-square estimation, Bayesian estimation, minimum mean square error (MMSE) estimation, etc. According to various implementations, the processing circuit 1302 may employ such calculations to the measured signal to determine or estimate one or more channel characteristics, such as interference levels, signal strength, noise floors, direction of departure, direction of arrival, etc.

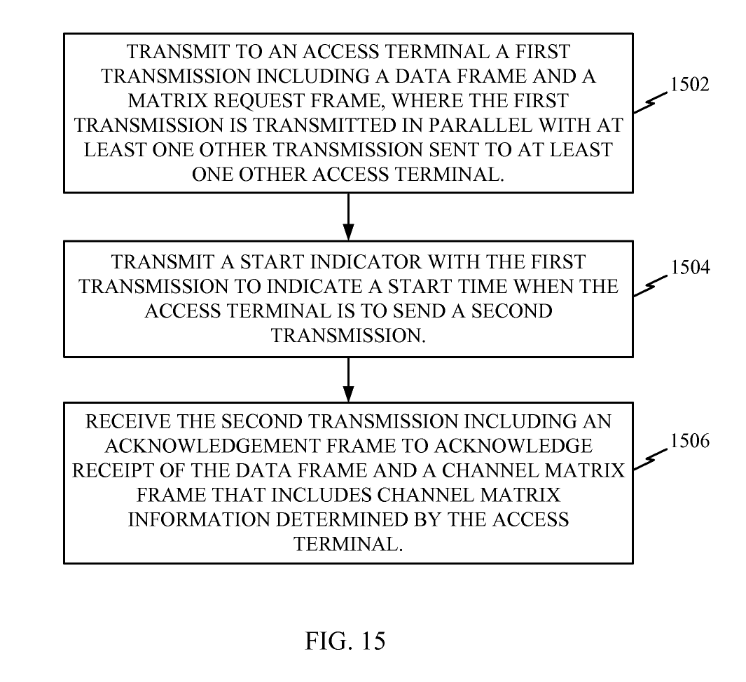

FIG. 15 is a flow diagram illustrating another example of at least one implementation of a method operational on an access point, such as access point 1300. With reference to both of FIGS. 13 and 15, the access point 1300 may transmit a first transmission to an access terminal at step 1502. For example, the processing circuit 1302 may transmit the first transmission via the communications interface 1304. The first transmission includes a data frame and a matrix request frame. The data frame may be transmitted as a user datagram protocol (UDP) frame. The data frame may comprise streaming video data.

The first transmission is transmitted in parallel (i.e., at least substantially concurrently) with at least one other transmission sent to at least one other access terminal. For example, the first transmission may be transmitted via a spatial division multiple access (SDMA) scheme.

A start indicator frame may also be transmitted with the first transmission at optional step 1504. The start indicator frame is adapted to indicate a start time when the access terminal is to send an acknowledgement frame during a second transmission opportunity. For example, the start indicator frame can comprise a demarcation indication (DI) frame or an uplink transmission time (UTT) frame.

The access point 1300 may then receive a second transmission at step 1506. For example, the processing circuit 1302 may be adapted to receive the second transmission via the communications interface 1304. The second transmission includes an acknowledgement frame to acknowledge receipt of the data frame, and a channel matrix information frame that includes channel matrix information determined by the access terminal. The second transmission may be received in parallel with at least one acknowledgement frame transmitted by the at least one other access terminal. In other implementations, the second transmission may be received in a sequential order with at least one acknowledgement frame transmitted by the at least one other access terminal.

One or more of the components, steps, features and/or functions illustrated in FIGS. 1, 2, 3, 4, 5, 6, 7, 8, 9, 10, 11, 12, 13, 14, 15 and/or 16 may be rearranged and/or combined into a single component, step, feature or function or embodied in several components, steps, or functions. Additional elements, components, steps, and/or functions may also be added without departing from the invention. The apparatus, devices, components and/or transmission frames illustrated in FIGS. 1, 2, 4, 5, 7, 8, 9, 10, 13 and/or 16 may be configured to perform one or more of the methods, features, or steps described in FIGS. 3, 6, 11, 12, 14 and/or 15. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium”, “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational on an access terminal, the method comprising:
receiving a data frame via a plurality of spatial streams and using a plurality of antennas, the data frame being received during a first transmission opportunity; and
transmitting an acknowledgement frame during a second transmission opportunity, the acknowledgement frame being transmitted as a sounding signal and to acknowledge receipt of the data frame.

2. The method of claim 1, wherein receiving the data frame comprises receiving a transmission in an Institute of Electrical and Electronics Engineers (IEEE) 802.11 wireless local area network (WLAN).

3. The method of claim 1, wherein receiving the data frame comprises receiving the data frame via a spatial division multiple access (SDMA) scheme.

4. The method of claim 1, wherein receiving the data frame comprises receiving a user datagram protocol (UDP) frame.

5. The method of claim 1, wherein receiving the data frame comprises receiving a data frame comprising streaming video data.

6. The method of claim 1, wherein transmitting the acknowledgement frame comprises:
transmitting the acknowledgement frame using the same spatial streams and the same antennas used to receive the data frame.

7. The method of claim 6, wherein transmitting the acknowledgement frame using the same spatial streams and the same antennas used to receive the data frame comprises:
identifying the spatial streams employed to receive the data frame;
identifying the antennas employed to receive the data frame; and
transmitting the acknowledgement frame using the same spatial streams and the same antennas.

8. The method of claim 1, wherein transmitting the acknowledgement frame comprises:
transmitting the acknowledgement frame concurrently with an acknowledgement frame transmitted by at least one other access terminal via a spatial division multiple access (SDMA) scheme.

9. The method of claim 1, wherein transmitting the acknowledgement frame comprises:
transmitting the acknowledgement frame in a sequential order with acknowledgement frames transmitted by one or more other access terminals.

10. An access terminal, comprising:
a communications interface including a plurality of antennas adapted to facilitate wireless communications; and
a processing circuit coupled to the communications interface, the processing circuit adapted to:
receive a data frame via a plurality of spatial streams and using at least some of the plurality of antennas of the communications interface, the data frame being received during a first transmission opportunity; and
send an acknowledgement frame during a second transmission opportunity, the acknowledgement frame being sent as a sounding signal and to acknowledge receipt of the data frame.

11. An access terminal, comprising:
means for receiving a data frame via a plurality of spatial streams using a plurality of antennas, the data frame being received during a first transmission opportunity; and
means for transmitting an acknowledgement frame during a second transmission opportunity, the acknowledgement frame being transmitted as a sounding signal and to acknowledge receipt of the data frame.

12. A processor-readable medium comprising one or more instructions operational on an access terminal, which when executed by a processing circuit, causes the processing circuit to:
receive a data frame via a plurality of spatial streams using a plurality of antennas, the data frame being received during a first transmission opportunity; and
transmit an acknowledgement frame during a second transmission opportunity, the acknowledgement frame being transmitted as a sounding signal and to acknowledge receipt of the data frame.

13. A method operational on an access point, the method comprising:
transmitting a respective data frame to each access terminal of a plurality of access terminals during a first transmission opportunity, wherein each data frame is transmitted to each access terminal via a plurality of spatial streams and using a plurality of antennas;
receiving an acknowledgement frame from each access terminal during a second transmission opportunity, each acknowledgement frame being received as a sounding signal and to acknowledge receipt of the data frame; and
determining channel matrix information associated with each access terminal using reception of the acknowledgement frame to ascertain one or more channel characteristics.

14. The method of claim 13, wherein transmitting the respective data frame to each access terminal of the plurality of access terminals during the first transmission opportunity comprises:
transmitting the respective data frame to each access terminal of the plurality of access terminals via a spatial division multiple access (SDMA) scheme.

15. The method of claim 13, wherein receiving the acknowledgement frame from each access terminal during the second transmission opportunity comprises:
receiving each acknowledgement frame using the same spatial streams and the same antennas used to transmit the data frame.

16. The method of claim 13, wherein receiving the acknowledgement frame from each access terminal during the second transmission opportunity comprises:
receiving the acknowledgement frame concurrently from each access terminal via a spatial division multiple access (SDMA) scheme.

17. The method of claim 13, wherein receiving the acknowledgement frame from each access terminal during the second transmission opportunity comprises:
receiving the acknowledgement frame from each access terminal in a sequential order during the second transmission opportunity.

18. The method of claim 13, wherein transmitting the respective data frame to each access terminal of the plurality of access terminals comprises:
transmitting a respective user datagram protocol (UDP) frame to each access terminal of the plurality of access terminals.

19. The method of claim 13, wherein transmitting the respective data frame to each access terminal of the plurality of access terminals comprises:
transmitting respective streaming video data to each access terminal of the plurality of access terminals.

20. The method of claim 13, wherein determining the channel matrix information associated with each access terminal using reception of the acknowledgement frame to ascertain one or more channel characteristics comprises:
measuring a signal associated with the received acknowledgement frame to ascertain the one or more channel characteristics.

21. The method of claim 20, wherein measuring the signal associated with the received acknowledgement frame to ascertain the one or more channel characteristics comprises:
employing at least one of a least-square estimation, a Bayesian estimation or a minimum mean square error (MMSE) estimation to ascertain the one or more channel characteristics.

22. The method of claim 13, wherein determining the channel matrix information associated with each access terminal using reception of the acknowledgement frame to ascertain one or more channel characteristics comprises:
determining the channel matrix information associated with each access terminal using reception of the acknowledgement frame to ascertain one or more of an interference level, a signal strength, a noise floor, a direction of departure or a direction of arrival.

23. An access point, comprising:
a communications interface adapted to facilitate wireless communications; and
a processing circuit coupled to the communications interface, the processing circuit adapted to:
transmit a respective data frame to each access terminal of a plurality of access terminals during a first transmission opportunity, wherein each data frame is transmitted to each access terminal via a plurality of spatial streams and using a plurality of antennas of the communications interface;
receive an acknowledgement frame from each access terminal during a second transmission opportunity, wherein each acknowledgement frame is received as a sounding signal and to acknowledge receipt of the data frame; and
determine channel matrix information associated with each access terminal using reception of the acknowledgement frame to ascertain one or more channel characteristics.

24. The access point of claim 23, wherein the communications interface is adapted to facilitate wireless communications in an Institute of Electrical and Electronics Engineers (IEEE) 802.11 wireless local area network (WLAN).

25. An access point, comprising:
means for transmitting a respective data frame to each access terminal of a plurality of access terminals during a first transmission opportunity, wherein each data frame is transmitted to each access terminal via a plurality of spatial streams and using a plurality of antennas;
means for receiving an acknowledgement frame from each access terminal during a second transmission opportunity, each acknowledgement frame being received as a sounding signal and to acknowledge receipt of the data frame; and
means for determining channel matrix information associated with each access terminal using reception of the acknowledgement frame to ascertain one or more channel characteristics.

26. A processor-readable medium comprising one or more instructions operational on an access point, which when executed by a processing circuit, causes the processing circuit to:
transmit a respective data frame to each access terminal of a plurality of access terminals during a first transmission opportunity, wherein each data frame is transmitted to each access terminal via a plurality of spatial streams and using a plurality of antennas;
receive an acknowledgement frame from each access terminal during a second transmission opportunity, each acknowledgement frame being received as a sounding signal and to acknowledge receipt of the data frame; and
determine channel matrix information associated with each access terminal using reception of the acknowledgement frame to ascertain one or more channel characteristics.

27. A method operational on an access terminal, the method comprising:
receiving a first transmission including a data frame and a matrix request frame;
determining channel matrix information for the access terminal; and
transmitting a second transmission including an acknowledgement frame to acknowledge receipt of the data frame and a channel matrix information frame that includes the channel matrix information determined by the access terminal.

28. The method of claim 27, wherein determining the channel matrix information for the access terminal comprises:
measuring a received signal to ascertain one or more channel characteristics; and
generating data depicting the one or more channel characteristics.

29. The method of claim 28, wherein measuring a received signal to ascertain one or more channel characteristics comprises:
measuring the received signal to ascertain one or more of an interference level, a signal strength, a noise floor, a direction of departure or a direction of arrival.

30. The method of claim 28, wherein generating data depicting the one or more channel characteristics comprises:
generating data depicting the one or more channel characteristics applying at least one of a least-square estimation, a Bayesian estimation or a minimum mean square error (MMSE) estimation to the measurements of the received signal.

31. The method of claim 27, wherein transmitting the second transmission comprises transmitting the second transmission concurrently with an acknowledgement frame transmitted by at least one other access terminal via a spatial division multiple access (SDMA) scheme.

32. The method of claim 27, wherein transmitting the second transmission comprises transmitting the second transmission in a sequential order with acknowledgement frames transmitted by one or more other access terminals.

33. The method of claim 27, wherein transmitting the first transmission including the data frame comprises transmitting the first transmission including a user datagram protocol (UDP) frame.

34. The method of claim 27, wherein transmitting the first transmission including the data frame comprises transmitting the first transmission including the data frame comprising streaming video data.

35. An access terminal, comprising:
a communications interface adapted to facilitate wireless communications; and
a processing circuit coupled to the communications interface, the processing circuit adapted to:
receive a first transmission via the communications interface, the first transmission including a data frame and a matrix request frame;
determine channel matrix information for the access terminal; and
send a second transmission via the communications interface, the second transmission including an acknowledgement frame to acknowledge receipt of the data frame and a channel matrix information frame that includes the channel matrix information determined by the access terminal.

36. The access terminal of claim 35, wherein the communications interface is adapted to facilitate wireless communications in an Institute of Electrical and Electronics Engineers (IEEE) 802.11 wireless local area network (WLAN).

37. The access terminal of claim 35, wherein the communications interface is adapted to facilitate wireless communications via a spatial division multiple access (SDMA) scheme.

38. An access terminal, comprising:
means for receiving a first transmission including a data frame and a matrix request frame;
means for determining channel matrix information for the access terminal; and
means for transmitting a second transmission including an acknowledgement frame to acknowledge receipt of the data frame and a channel matrix information frame that includes the channel matrix information determined by the access terminal.

39. A processor-readable medium comprising one or more instructions operational on an access terminal, which when executed by a processing circuit, causes the processing circuit to:
receive a first transmission including a data frame and a matrix request frame;
determine channel matrix information for the access terminal; and
transmit a second transmission including an acknowledgement frame to acknowledge receipt of the data frame and a channel matrix information frame that includes the channel matrix information determined by the access terminal.

40. A method operational on an access point, the method comprising:
transmitting to an access terminal a first transmission including a data frame and a matrix request frame, wherein the first transmission is transmitted in parallel with at least one other transmission sent to at least one other access terminal; and
receiving a second transmission including an acknowledgement frame to acknowledge receipt of the data frame and a channel matrix information frame that includes channel matrix information determined by the access terminal.

41. The method of claim 40, wherein transmitting the first transmission in parallel with the at least one other transmission includes transmitting the first transmission and the at least one other transmission concurrently via a spatial division multiple access (SDMA) scheme.

42. The method of claim 40, wherein receiving the second transmission includes receiving the second transmission in parallel with at least one acknowledgement frame transmitted by the at least one other access terminal.

43. The method of claim 40, wherein receiving the second transmission includes receiving the second transmission in a sequential order with at least one acknowledgement frame transmitted by the at least one other access terminal.

44. The method of claim 40, wherein transmitting the first transmission including the data frame comprises transmitting the first transmission including a user datagram protocol (UDP) frame.

45. The method of claim 40, wherein transmitting the first transmission including the data frame comprises transmitting the first transmission including the data frame comprising streaming video data.

46. An access point, comprising:
a communications interface adapted to facilitate wireless communications; and
a processing circuit coupled to the communications interface, the processing circuit adapted to:
transmit a first transmission to an access terminal via the communications interface, the first transmission including a data frame and a matrix request frame, wherein the first transmission is transmitted in parallel with at least one other transmission sent to at least one other access terminal; and
receive a second transmission via the communications interface, the second transmission including an acknowledgement frame to acknowledge receipt of the data frame and a channel matrix information frame that includes channel matrix information determined by the access terminal.

47. The access point of claim 46, wherein the communications interface is adapted to facilitate wireless communications in an Institute of Electrical and Electronics Engineers (IEEE) 802.11 wireless local area network (WLAN).

48. An access point, comprising:
means for transmitting to an access terminal a first transmission including a data frame and a matrix request frame, wherein the first transmission is transmitted in parallel with at least one other transmission sent to at least one other access terminal; and
means for receiving a second transmission including an acknowledgement frame to acknowledge receipt of the data frame and a channel matrix information frame that includes channel matrix information determined by the access terminal.

49. A processor-readable medium comprising one or more instructions operational on an access point, which when executed by a processing circuit, causes the processing circuit to:
transmit to an access terminal a first transmission including a data frame and a matrix request frame, wherein the first transmission is transmitted in parallel with at least one other transmission sent to at least one other access terminal; and
receive a second transmission including an acknowledgement frame to acknowledge receipt of the data frame and a channel matrix information frame that includes channel matrix information determined by the access terminal.
